(19) United States
(12) Patent Application Publication
(10) Pub. No.: US 2024/0002414 A1
(43) Pub. Date: Jan. 4, 2024

(54) Method of Making a Phosphite Ester

(71) Applicant: SI Group, Inc., The Woodlands, TX (US)

(72) Inventors: Keyur Pandya, Morgantown, WV (US); Brian Huffman, Morgantown, WV (US)

(21) Appl. No.: 18/189,516

(22) Filed: Mar. 24, 2023

Related U.S. Application Data
(60) Provisional application No. 63/356,749, filed on Jun. 29, 2022.

(51) Int. Cl. C07F 9/145

(52) U.S. Cl. CPC C07F 9/145

(57) ABSTRACT

The present disclosure is directed to a method of making a phosphite ester. The method comprises reacting a hydroxyl-substituted compound comprising a hydroxyl-substituted alkyl compound, a hydroxyl-substituted aryl compound, or a mixture thereof with a phosphorus halide to make a product mixture comprising a hydrogen halide and a reaction product comprising the phosphite ester and a phosphohalodite and removing the hydrogen halide from the product mixture.

### CROSS-REFERENCE TO RELATED APPLICATION

The present application claims filing benefit of U.S. Provisional Patent Application No. 63/356,749 having a filing date of Jun. 29, 2022, which is hereby incorporated by reference in its entirety.

### BACKGROUND OF THE INVENTION

Phosphite esters (e.g., organophosphites) have many industrial applications. In this regard, phosphite esters may be used as additives for a number of chemical transformations, such as catalysts for accelerating reaction rates and as antioxidants for boosting of polymer durability, weathering resistance, material properties, and recyclability for sustainability.

Furthermore, these phosphite esters can be synthesized using various techniques in the art. For instance, certain reaction schemes may require a catalyst. Other reaction schemes may require relatively high temperatures. In this regard, such reactions may generally be more complex than desired in order to obtain a product having a satisfactory yield and/or purity. Furthermore, as processes are tailored to be more economically efficient, energy friendly, and environmentally friendly, it can be desired to find a less complex and/or more efficient process for manufacturing phosphite esters.

As such, a need continues to exist for a more efficient and/or less complex method of making phosphite esters.

### SUMMARY OF THE INVENTION

In accordance with one embodiment of the present invention, a method of making a phosphite ester is disclosed. The method comprises: reacting a hydroxyl-substituted compound comprising a hydroxyl-substituted alkyl compound, a hydroxyl-substituted aryl compound, or a mixture thereof with a phosphorus halide, wherein the hydroxyl-substituted compound and the phosphorus halide are reacted in a molar ratio of from about 2.3 to about 5, at a temperature of about 200° C. or less to make a product mixture comprising a hydrogen halide and a reaction product comprising the phosphite ester and one or more compounds having the following structure (I) and being present in an amount of about 0.3 wt. % or more to about 15 wt. % or less based on the weight of the reaction product:

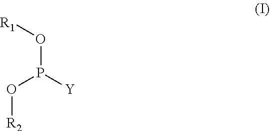

wherein R₁ is an alkyl or an aryl, R₂ is an alkyl or an aryl, Y is -Z or —O—H, and Z is a halide; and removing the hydrogen halide from the product mixture.

In accordance with another embodiment of the present invention, a method of making a phosphite ester is disclosed. The method comprises: reacting a hydroxyl-substituted compound comprising a hydroxyl-substituted alkyl compound, a hydroxyl-substituted aryl compound, or a mixture thereof with a phosphorus halide, wherein the hydroxyl-substituted compound and the phosphorus halide are reacted in a molar ratio of from about 2.3 to about 5, to make a product mixture comprising a hydrogen halide and a reaction product comprising the phosphite ester and a phosphohalodite, wherein the phosphohalodite is present in an amount of from about 0.5 wt. % or more to about wt. % or less based on the weight of the reaction product; and removing the hydrogen halide from the product mixture using a vacuum.

In accordance with another embodiment of the present invention, a method of making a phosphite ester is disclosed. The method comprises: reacting a hydroxyl-substituted compound comprising a hydroxyl-substituted alkyl compound, a hydroxyl-substituted aryl compound, or a mixture thereof with a phosphorus halide, wherein the hydroxyl-substituted compound and the phosphorus halide are reacted in a molar ratio of from about 2.3 to about 5, to make a product mixture comprising a hydrogen halide and a reaction product comprising the phosphite ester and a phosphohalodite, wherein the phosphohalodite is present in an amount of from about 0.5 wt. % or more to about wt. % or less based on the weight of the reaction product; and removing the hydrogen halide from the product mixture using a nitrogen sparge and/or a nitrogen sweep.

In accordance with another embodiment of the present invention, a method of making a phosphite ester is disclosed. The method comprises: reacting a hydroxyl-substituted compound comprising a hydroxyl-substituted alkyl compound, a hydroxyl-substituted aryl compound, or a mixture thereof with a phosphorus halide, wherein the hydroxyl-substituted compound and the phosphorus halide are reacted in a molar ratio of from about 2.3 to about 5, to make a product mixture comprising a hydrogen halide and a reaction product comprising the phosphite ester and a phosphohalodite wherein the reaction product has a predetermined halide content, wherein the phosphohalodite is present in an amount of from about 0.5 wt. % or more to about 15 wt. % or less based on the weight of the reaction product; and removing the hydrogen halide from the product mixture using a nitrogen sweep.

Other features and aspects of the present disclosure are set forth in greater detail below.

### BRIEF DESCRIPTION OF THE DRAWINGS

The disclosure will now be described, by way of example, with reference to the accompanying drawings, in which:

FIG. 1A illustrates a reaction scheme in accordance with one embodiment of the present disclosure;

FIG. 1B illustrates a reaction scheme in accordance with another embodiment of the present disclosure;

FIG. 2 illustrates temperature versus time for a reaction scheme in accordance with one embodiment of the present disclosure including a relatively high chloride content;

FIG. 3 illustrates temperature versus time for a reaction scheme in accordance with one embodiment of the present disclosure including a relatively low chloride content;

FIG. 4 illustrates % TTP formation as a function of cresol/PCl₃ molar ratio in accordance with one embodiment of the present disclosure;

FIG. 5 illustrates % phosphochlorodite formation as a function of cresol/PCl₃ molar ratio in accordance with one embodiment of the present disclosure;

FIG. 6 illustrates % cresol remaining as a function of cresol/PCl₃ molar ratio;

FIG. 7 illustrates chloride ppm in the reaction product as a function of cresol/PCl₃ molar ratio in accordance with one embodiment of the present disclosure;

FIGS. 8A and 8B illustrate a nitrogen sparge tube in accordance with one embodiment of the present disclosure;

FIG. 9 illustrates a process diagram of a reaction scheme in accordance with one embodiment of the present disclosure; and

FIG. 10 illustrates a reaction vessel in accordance with one embodiment of the present disclosure.

### DEFINITIONS

It is to be understood that the terminology used herein is for the purpose of describing particular embodiments only and is not intended to limit the scope of the present disclosure.

“About” means within 5% of the disclosed value.

“Alkyl” refers to straight chain, branched chain, or cyclic monovalent saturated aliphatic hydrocarbyl groups and “C_{q}-Cᵣ alkyl” refers to alkyl groups having from q to r carbon atoms. This term includes, by way of example, straight chain, branched chain, or cyclic hydrocarbyl groups, such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosanyl, henicosanyl, docosanyl, tricosanyl, tetracosanyl, pentacosanyl, hexacosanyl, heptacosanyl, octacosanyl, and the like.

“Aryl” refers to an aromatic hydrocarbyl group. For example, “C_{q}-Cᵣ aryl” refers to aryl groups having from q to r carbon atoms. This term includes, by way of example, linear and branched hydrocarbyl groups, such as phenyl, naphthyl, indenyl, azulenyl, fluorenyl, anthracenyl, phenanthrenyl, tetrahydronaphthyl, indanyl, phenanthridinyl and the like.

### DETAILED DESCRIPTION

It is to be understood by one of ordinary skill in the art that the present discussion is a description of exemplary embodiments only and is not intended as limiting the broader aspects of the present disclosure.

Generally speaking, the present disclosure is directed to a method of making a phosphite ester. Namely, by controlling the method and processing conditions, the present inventors have discovered that the method disclosed herein may allow for a more effective and efficient reaction. For instance, the reaction may be conducted at a relatively lower temperature which inherently has its own benefits. Furthermore, the reaction, as well as post-reaction steps if any, may be conducted within one single vessel. In this regard, the present inventors have discovered that the method as disclosed herein may be environmentally friendly as well as energy friendly. In addition, the method described herein may be conducted without or in the absence of distillation, recycling, or further purification of reaction products comprising the phosphite ester and any phosphohalodites, such as phosphochlorodites. Particularly, the method may be conducted without distillation for purification of the product mixture or reaction product as defined herein.

The method according to the present disclosure includes a step of reacting a hydroxyl-substituted compound comprising a hydroxyl-substituted alkyl compound, a hydroxyl-substituted aryl compound, or a mixture thereof with a phosphorus halide. In general, the hydroxyl-substituted compound may be referred to as an alcohol. In one embodiment, the reaction includes a hydroxyl-substituted alkyl compound. In another embodiment, the reaction includes a hydroxyl-substituted aryl compound. In a further embodiment, the reaction includes a mixture of a hydroxyl-substituted alkyl compound and a hydroxyl-substituted aryl compound.

In addition, regarding the aforementioned hydroxyl-substituted compound, such compound may only have one hydroxyl substitution in one embodiment. In another embodiment, such compound may have two hydroxyl substitutions.

The alkyl of the hydroxyl-substituted alkyl compound may be a C₁-C₁₀ alkyl. In this regard, the alkyl may be a C₁-C₁₀ alkyl, such as a C₁-C₈ alkyl, such as a C₁-C₆ alkyl, such as a C₁-C₄ alkyl, such as a C₁-C₃ alkyl, such as a C₁-C₂ alkyl, such as a C₁ alkyl. For instance, the alkyl may have 1 or more, such as 2 or more, such as 3 or more, such as 4 or more, such as 5 or more carbon atoms. The alkyl may have 10 or less, such as 8 or less, such as 6 or less, such as 5 or less, such as 4 or less, such as 3 or less, such as 2 or less carbon atoms. In this regard, the alkyl may be heptyl, hexyl, pentyl (e.g., n-pentyl, sec-pentyl, iso-pentyl, tert-pentyl, neo-pentyl), butyl (e.g., n-butyl, sec-butyl, iso-butyl, tert-butyl), propyl (e.g., n-propyl, iso-propyl), ethyl, methyl, etc. In one particular embodiment, the alkyl may be methyl. In addition, the alkyl may be a straight chain, a branched chain, or cyclic. In one embodiment, the alkyl is a straight chain. In another embodiment, the alkyl is a branched chain. In a further embodiment, the alkyl is cyclic (or cycloalkyl).

Aside from the hydroxyl substitution(s), in one embodiment, the aforementioned alkyl may not include any further substitutions. In another embodiment, aside from the hydroxyl substitution(s), the aforementioned alkyl may include further substitutions. For instance, the alkyl may be an arylkyl (i.e., an alkyl substituted with an aryl group). The aryl may be a C₃-C₁₂ aryl. In this regard, the aryl may be a C₃-C₁₂ aryl, such as a C₄-C₁₂ aryl, such as a C₆-C₁₂ aryl, such as a C₆-C₁₀ aryl, such as a C₆-C₈ aryl, such as a C6 aryl. For instance, the aryl may have 3 or more, such as 4 or more, such as 5 or more, such as 6 or more carbon atoms. The aryl may have 12 or less, such as 10 or less, such as 8 or less, such as 7 or less, such as 6 or less, such as 5 or less carbon atoms. In one particular embodiment, the aryl may be a phenyl. In addition, in one embodiment, the aryl may be polycyclic. The polycyclic aryl may include fused, bridged, and spiro ring systems.

Regardless, the hydroxyl-substituted alkyl compound may be one generally known in the art. For instance, the compound may be methanol, an ethanol, a propanol, a butanol, a pentanol, a cyclopentanol, a hexanol, a cyclohexanol, and the like as well as mixtures thereof. In one embodiment, the compound may be methanol, an ethanol, a propanol, a butanol, a pentanol, a hexanol, or a mixture thereof. In a further embodiment, the compound may be a cycloalkyl such as a cyclopentanol, a cyclohexanol, or a mixture thereof.

The aforementioned aryl of the hydroxyl-substituted aryl compound may be a C₃-C₁₂ aryl. In this regard, the aryl may be a C₃-C₁₂ aryl, such as a C₄-C₁₂ aryl, such as a C₆-C₁₂ aryl, such as a C₆-C₁₀ aryl, such as a C₆-C₈ aryl, such as a C₆ aryl. For instance, the aryl may have 3 or more, such as 4 or more, such as 5 or more, such as 6 or more carbon atoms. The aryl may have 12 or less, such as 10 or less, such as 8 or less, such as 7 or less, such as 6 or less, such as 5 or less carbon atoms. In one particular embodiment, the aryl may be a phenyl. In addition, in one embodiment, the aryl may be polycyclic. The polycyclic aryl may include fused, bridged, and spiro ring systems.

Aside from the hydroxyl substitution(s), in one embodiment, the aforementioned aryl may not include any further substitutions. In another embodiment, aside from the hydroxyl substitution(s), the aforementioned aryl may include further substitutions. For instance, the aryl may be an alkaryl (i.e., an aryl substituted with an alkyl group). The alkyl may be a C₁-C₁₀ alkyl. In this regard, the alkyl may be a C₁-C₁₀ alkyl, such as a C₁-C₈ alkyl, such as a C₁-C₆ alkyl, such as a C₁-C₄ alkyl, such as a C₁-C₃ alkyl, such as a C₁-C₂ alkyl, such as a C₁ alkyl. For instance, the alkyl may have 1 or more, such as 2 or more, such as 3 or more, such as 4 or more, such as 5 or more carbon atoms. The alkyl may have 10 or less, such as 8 or less, such as 6 or less, such as 5 or less, such as 4 or less, such as 3 or less, such as 2 or less carbon atoms. In this regard, the alkyl may be heptyl, hexyl, pentyl (e.g., n-pentyl, sec-pentyl, iso-pentyl, tert-pentyl, neo-pentyl), butyl (e.g., n-butyl, sec-butyl, iso-butyl, tert-butyl), propyl (e.g., n-propyl, iso-propyl), ethyl, methyl, etc. In one particular embodiment, the alkyl may be methyl. In addition, the alkyl may be a straight chain, a branched chain, or cyclic. In one embodiment, the alkyl is a straight chain. In another embodiment, the alkyl is a branched chain. In a further embodiment, the alkyl is cyclic (or cycloalkyl).

Regardless, the hydroxyl-substituted aryl compound may be one generally known in the art. For instance, the compound may be a phenol, a benzyl alcohol, and the like. In one embodiment, the compound may be a phenol. For instance, the compound may be phenol, such as a phenol without any further substitutions. In another embodiment, the phenol may be an alkyl substituted phenol, such as a dialkyl substituted phenol. For instance, the phenol may include cresol (e.g., o-cresol, m-cresol, p-cresol, or a mixture thereof), xylenol (e.g., 2,6-xylenol, 2,5-xylenol, 2,4-xylenol, 2,3-xylenol, 3,4-xylenol, 3,5-xylenol, or a mixture thereof), or a mixture thereof. In this regard, in one embodiment, the hydroxyl-substituted aryl compound may include phenol, o-cresol, m-cresol, p-cresol, 2,6-xylenol, 2,5-xylenol, 2,4-xylenol, 2,3-xylenol, 3,4-xylenol, 3,5-xylenol, or a mixture thereof. In another embodiment, the hydroxyl-substituted aryl compound may include phenol, o-cresol, m-cresol, p-cresol, or a mixture thereof. More generally, the hydroxyl-substituted aryl compound may include phenol, cresol, or a mixture thereof. In this regard, in one embodiment, the hydroxyl-substituted aryl compound may include a mixture of phenol and a cresol. In a further embodiment, the hydroxyl-substituted aryl compound may include a cresol, in particular o-cresol, m-cresol, p-cresol, or a mixture thereof. In another further embodiment, the hydroxyl-substituted aryl compound may include m-cresol, p-cresol, or a mixture thereof. In an even further embodiment, the hydroxyl-substituted aryl compound may include a mixture of m-cresol and p-cresol. In one particular embodiment, the hydroxyl-substituted compound, such as the hydroxyl-substituted aryl compound, may not include o-cresol.

When more than one hydroxyl-substituted compound is utilized such that a first hydroxyl-substituted compound and a second hydroxyl-substituted compound is utilized, the ratio between any two may be within a certain predetermined ratio. For instance, the ratio may be about 0.1 or more, such as about 0.2 or more, such as about 0.3 or more, such as about 0.5 or more, such as about 0.8 or more, such as about 1 or more, such as about 1.2 or more, such as about 1.4 or more, such as about 1.5 or more, such as about 1.6 or more, such as about 1.7 or more, such as about 1.8 or more, such as about 2 or more, such as about 2.3 or more, such as about 2.5 or more, such as about 3 or more, such as about 4 or more, such as about 5 or more. The predetermined ratio may be about 20 or less, such as about 18 or less, such as about 16 or less, such as about 15 or less, such as about 13 or less, such as about 11 or less, such as about 10 or less, such as about 9 or less, such as about 8 or less, such as about 7 or less, such as about 6 or less, such as about 5 or less, such as about 4 or less, such as about 3.8 or less, such as about 3.5 or less, such as about 3.2 or less, such as about 3 or less, such as about 2.8 or less, such as about 2.5 or less, such as about 2.3 or less, such as about 2.1 or less, such as about 2 or less, such as about 1.9 or less, such as about 1.8 or less, such as about 1.7 or less, such as about 1.6 or less, such as about 1.5 or less, such as about 1.3 or less, such as about 1.1 or less, such as about 1 or less. In one embodiment, the aforementioned ratio may refer to a weight ratio. In another embodiment, the aforementioned ratio may refer to a molar ratio.

As an example, the hydroxyl-substituted compound may be a hydroxyl-substituted aryl compound comprising a combination of m-cresol and p-cresol. In this regard, as one example, the aforementioned ratio may refer to the weight ratio between m-cresol and p-cresol. In another embodiment, the aforementioned ratio may refer to the molar ratio between m-cresol and p-cresol.

In one embodiment, the hydroxyl-substituted aryl compound may not include phenol (i.e., unsubstituted phenol—one having only a hydroxyl substitution). In this regard, the hydroxyl-substituted compound, in particular the hydroxyl-substituted aryl compound, may include about 15 wt. % or less, such as about 12 wt. % or less, such as about 10 wt. % or less, such as about 8 wt. % or less, such as about 6 wt. % or less, such as about 4 wt. % or less, such as about 2 wt. % or less, such as about 1 wt. % or less, such as about 0.5 wt. % or less, such as about 0.3 wt. % or less, such as about 0.2 wt. % or less, such as about 0.1 wt. % or less, such as about 0.05 wt. % or less, such as about 0 wt. % of phenol. However, for the sake of clarity, the reaction may still include substituted phenols, such as cresols or xylenols, as the hydroxyl-substituted compound, in particular the hydroxyl substituted aryl compound. While the aforementioned refers to the hydroxyl-substituted aryl compound, it should be understood that in one embodiment, such limitation may also apply to any other reaction inputs or reagents for making the phosphite ester. In this regard, the aforementioned percentages may apply to any single reaction input or reagent in one embodiment. In addition, the aforementioned percentages may apply to the combination of other reaction inputs or reagents in another embodiment.

As indicated above, the reaction includes a phosphorus halide. In this regard, the halide may be a fluoride, a chloride, a bromide, an iodide, or a mixture thereof. In one embodiment, the halide may be a chloride. Furthermore, the phosphorus halide may be a phosphorus trihalide. For instance, the phosphorus halide may be a phosphorus trifluoride, a phosphorus trichloride, a phosphorus tribromide, a phosphorus triiodide, or a mixture thereof. In one embodiment, the phosphorus halide may be a phosphorus trichloride.

The hydroxyl-substituted compound and the phosphorus halide may be utilized in the reaction in particular amounts. For instance, the molar ratio of the hydroxyl-substituted compound to the phosphorus halide may be about 0.1 or more, such as about 0.2 or more, such as about 0.3 or more, such as about 0.5 or more, such as about 0.7 or more, such as about 0.8 or more, such as about 1 or more, such as about 1.2 or more, such as about 1.5 or more, such as about 1.7 or more, such as about 1.9 or more, such as about 2 or more, such as about 2.3 or more, such as about 2.5 or more, such as about 2.7 or more, such as about 2.8 or more, such as about 2.81 or more, such as about 2.82 or more, such as about 2.83 or more, such as about 2.84 or more, such as about 2.85 or more, such as about 2.86 or more, such as about 2.87 or more, such as about 2.88 or more, such as about 2.89 or more, such as about 2.9 or more, such as about 2.91 or more, such as about 2.92 or more, such as about 2.93 or more, such as about 2.94 or more, such as about 2.95 or more, such as about 2.96 or more, such as about 2.97 or more, such as about 2.98 or more, such as about 2.99 or more, such as about 3 or more. The molar ratio may be about 20 or less, such as about 18 or less, such as about 16 or less, such as about 14 or less, such as about 12 or less, such as about 10 or less, such as about 9 or less, such as about 8 or less, such as about 7 or less, such as about 6 or less, such as about 5 or less, such as about 4.5 or less, such as about 4 or less, such as about 3.5 or less, such as about 3 or less, such as about 2.99 or less, such as about 2.98 or less, such as about 2.97 or less, such as about 2.96 or less, such as about 2.95 or less, such as about 2.94 or less, such as about 2.93 or less, such as about 2.92 or less, such as about 2.91 or less, such as about 2.9 or less, such as about 2.89 or less, such as about 2.88 or less, such as about 2.87 or less, such as about 2.86 or less, such as about 2.85 or less, such as about 2.84 or less, such as about 2.83 or less, such as about 2.82 or less, such as about 2.81 or less, such as about 2.8 or less, such as about 2.7 or less, such as about 2.5 or less, such as about 2 or less, such as about 1.8 or less, such as about 1.5 or less. For example, the molar ratio may be from about 2.3 to about 5, such as from about 2.3 to about 4, such as from about 2.3 to about 3.5, such as from about 2.3 to less than about 3. The minimum in the aforementioned ranges may be any of about 2.5, about 2.6, about 2.7, about 2.8. In one embodiment, the molar ratio may be from about 2.8 to about 2.9, such as from about 2.85 to about 2.9. In another embodiment, the molar ratio may be from about 2.9 to less than about 3, such as from about 2.95 to less than about 3.

In this regard, the hydroxyl-substituted compound may be present in an amount of about 50 mol. % or more, such as about 55 mol. % or more, such as about 60 mol. % or more, such as about 65 mol. % or more, such as about 70 mol. % or more, such as about 75 mol. % or more, such as about 80 mol. % or more, such as about 85 mol. % or more, such as about 90 mol. % or more, such as about mol. % or more based on the total moles of the hydroxyl-substituted compound and the phosphorus halide. The hydroxyl-substituted compound may be present in an amount of less than about 100 mol. %, such as about 95 mol. % or less, such as about 90 mol. % or less, such as about 85 mol. % or less, such as about 80 mol. % or less, such as about 75 mol. % or less based on the total moles of the hydroxyl-substituted compound and the phosphorus halide.

Also, the phosphorus halide may be present in an amount of about 50 mol % or less, such as about 45 mol % or less, such as about 40 mol % or less, such as about 35 mol % or less, such as about 30 mol % or less, such as about 25 mol % or less, such as about 20 mol % or less, such as about 15 mol % or less, such as about 10 mol % or less based on the total moles of the hydroxyl-substituted compound and the phosphorus halide. The phosphorus halide may be present in an amount of more than 0 mol. %, such as about 1 mol. % or more, such as about 2 mol. % or more, such as about 5 mol. % or more, such as about 10 mol. % or more, such as about 15 mol. % or more, such as about 20 mol. % or more, such as about 25 mol. % or more based on the total moles of the hydroxyl-substituted compound and the phosphorus halide.

As indicated herein, the reaction may occur in a vessel, in particular a single vessel. The reaction vessel may be any as generally utilized for such a reaction. For instance, the vessel may be one allowing for batch processes. Regardless, in one embodiment, the manner in which the reactants are introduced may not necessarily be restricted. In another embodiment, at least some, such as all, of the hydroxy-substituted compound may first be provided to the vessel. Thereafter, the phosphorus halide may be provided or charged to the vessel. In one embodiment, the phosphorus halide may be provided or charged sub-surface (i.e., below the surface of cresols—cresol/gas interface).

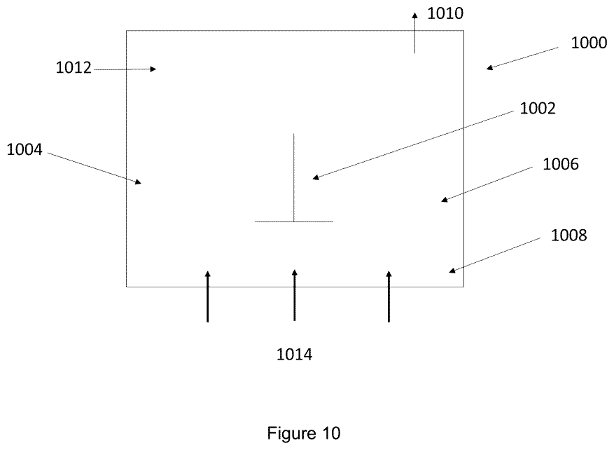

As one example, the reaction vessel may be one as illustrated in FIG. 10. For instance, the vessel 1000 may include an agitator 1002, such as an impeller or mixer. The vessel may also include an inlet 1004 for the introduction of the hydroxyl-substituted compound, such as cresol, and optionally a second inlet 1006 for the addition of phosphorous halide. In addition, the vessel may also include an inlet 1008, such as one for sub-surface introduction, of the phosphorus halide, such as phosphorus trichloride. The vessel may also include an exit for removal of hydrogen halide 1010, such as hydrogen chloride, as well as any nitrogen that may be introduced via a nitrogen sweep 1012 and/or nitrogen sparge 1014. The vessel may also include one or more inlets for nitrogen sparge sub-surface through a reaction mass 1008. In addition, the vessel may include a port or inlet to allow for negative pressure or vacuum 1012.

In addition, the phosphorus halide may be provided or charged over a period of time. For instance, the phosphorus halide may be provided over a course of about 0.1 hours or more, such as about 0.5 hours or more, such as about 1 hour or more, such as about 1.5 hours or more, such as about 2 hours or more, such as about 3 hours or more, such as about 4 hours or more, such as about 5 hours or more. The phosphorus halide may be provided over a course of about 10 hours or less, such as about 8 hours or less, such as about 6 hours or less, such as about 5 hours or less, such as about 4 hours or less, such as about 3 hours or less.

Similarly, of the total volume of the phosphorus halide to be introduced, it may be introduced at a certain rate. For instance, the rate of introduction of the phosphorus halide may be at least 0.1%/min, such as at least 0.2%/min, such as at least 0.3%/min, such as at least 0.5%/min, such as at least 0.6%/min, such as at least 0.8%/min, such as at least 1%/min, such as at least 1.1%/min, such as at least 1.2%/min, such as at least 1.5%/min wherein the % is based on the total volume of the phosphorus halide to be charged. In addition, the rate may be 10%/min or less, such as 9%/min or less, such as 8%/min or less, such as 7%/m in or less, such as 6%/m in or less, such as 5%/m in or less, such as 4%/min or less, such as 3%/min or less, such as 2.8%/min or less, such as 2.5%/min or less, such as 2.2%/min or less, such as 2%/min or less, such as 1.8%/min or less, such as 1.5%/min or less, such as 1.3%/min or less, such as 1.1%/min or less, such as 1%/min or less wherein the % is based on the total volume of the phosphorus halide to be charged.

In addition, the phosphorus halide may be introduced or charged at a relatively lower temperature. In other words, the contents of the vessel may be at a reduced temperature. For instance, the temperature may be about 150° C. or less, such as about 140° C. or less, such as about 130° C. or less, such as about 120° C. or less, such as about 110° C. or less, such as about 100° C. or less, such as about 90° C. or less, such as about 80° C. or less, such as about 70° C. or less, such as about 60° C. or less. The temperature may be room temperature or more. For instance, the temperature may be about 20° C. or more, such as about 25° C. or more, such as about 30° C. or more, such as about 40° C. or more, such as about 50° C. or more, such as about 60° C. or more, such as about 70° C. or more, such as about 80° C. or more, such as about 90° C. or more. If needed, such temperature of the vessel could be maintained using cooling means generally known in the art.

By using the method as disclosed herein, the reaction itself may be conducted at a relatively low temperature as well. For instance, the reaction may be conducted at a temperature of about 250° C. or less, such as about 230° C. or less, such as about 210° C. or less, such as about 200° C. or less, such as about 180° C. or less, such as about 160° C. or less, such as about 150° C. or less, such as about 140° C. or less, such as about 130° C. or less, such as about 120° C. or less, such as about 110° C. or less, such as about 100° C. or less, such as about 90° C. or less, such as about 80° C. or less, such as about 70° C. or less, such as about 60° C. or less. The reaction temperature may be room temperature or more. For instance, the temperature may be about 20° C. or more, such as about 25° C. or more, such as about 30° C. or more, such as about 40° C. or more, such as about 50° C. or more, such as about 60° C. or more, such as about 70° C. or more, such as about 80° C. or more, such as about 90° C. or more, such as about 100° C. or more, such as about 110° C. or more, such as about 120° C. or more, such as about 130° C. or more, such as about 140° C. or more. In one embodiment, the reaction temperature may be at a temperature greater than the temperature at which the phosphorus halide is introduced.

Accordingly, upon completion of the charge of the phosphorus halide, the temperature may be increased to the reaction temperature. In general, such increase in temperature may be using any heating means as generally known in the art. For instance, this may include a heating jacket as one example.

In one embodiment, the reaction may be conducted in a solvent. For instance, the solvent may be an aprotic solvent. The solvent may include an aliphatic solvent, an aromatic solvent, or a mixture thereof. Examples of such solvents may include toluene, xylene, ethylbenzene, etc. However, in another embodiment, the reaction may be conducted without a solvent.

In one embodiment, the reaction may be conducted without the presence of a catalyst, such as an amine-based catalyst. In this regard, the hydroxyl-substituted compound and the phosphorus halide may be reacted based on the reaction conditions themselves such that a catalyst may not be required to form the product mixture comprising a hydrogen halide and a reaction product comprising the phosphite ester wherein the reaction product has a predetermined halide content.

In addition, the reaction may be conducted at any pressure that will allow for formation of the phosphite ester. For instance, the reaction may be conducted at a pressure of about 0.5 atm or more, such as about 0.6 atm or more, such as about 0.7 atm or more, such as about 0.8 atm or more, such as about 0.9 atm or more, such as about 1 atm or more. The pressure may be about 1.5 atm or less, such as about 1.4 atm or less, such as about 1.3 atm or less, such as about 1.2 atm or less, such as about 1.1 atm or less. The pressure may be about 1 atm.

Also, the reaction time may be relatively lower than certain traditional methods. For instance, the reaction time may be about 15 hours or less, such as about 14 hours or less, such as about 13 hours or less, such as about 12 hours or less, such as about 11 hours or less, such as about 10 hours or less, such as about 9 hours or less, such as about 8 hours or less, such as about 7 hours or less, such as about 6 hours or less, such as about 5 hours or less, such as about 4 hours or less, such as about 3 hours or less, such as about 2 hours or less. The reaction time may be about 0.5 hours or more, such as about 1 hour or more, such as about 2 hours or more, such as about 3 hours or more, such as about 4 hours or more, such as about 5 hours or more, such as about 6 hours or more, such as about 7 hours or more, such as about 8 hours or more, such as about 9 hours or more, such as about 10 hours or more, such as about 11 hours or more, such as about 12 hours or more.

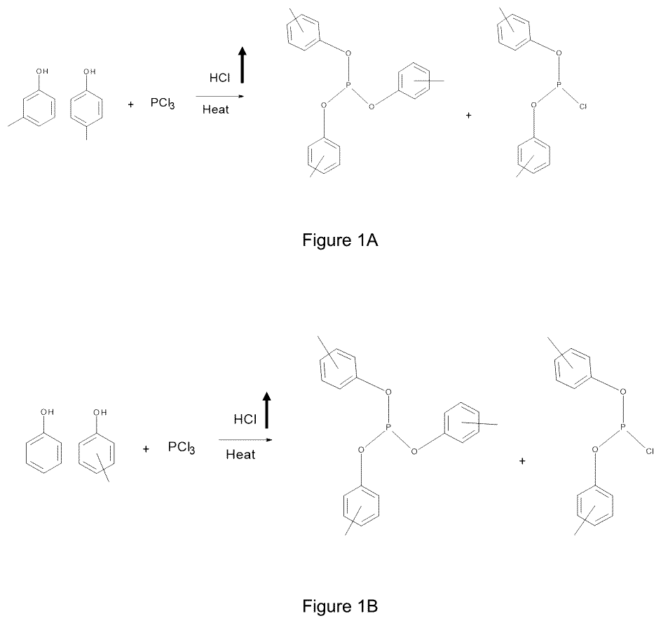

In general, the reaction between the hydroxyl-substituted compound and the phosphorus halide will result in a product mixture comprising hydrogen halide and a reaction product. The reaction product comprises at least a phosphite ester. In another embodiment, the reaction product comprises a phosphite ester and one or more phosphohalodites. In one particular embodiment, the reaction product comprises a phosphite ester and a phosphohalodite. A reaction scheme in accordance with one embodiment of the present disclosure is presented in FIG. 1A. This reaction scheme illustrates a reaction between m-cresol/p-cresol and phosphorus trichloride for the synthesis of tristolylphosphite and the corresponding phosphochlorodites. However, as indicated herein, it should be understood that the reaction may also be conducted using phenol in conjunction with one or more hydroxyl substituted compounds, such as one or more cresols, and phosphorus trichloride as indicated in FIG. 1B.

As indicated above, the reaction may result in the formation of a hydrogen halide, generally as a by-product. The halide may be dictated by the halide utilized in the phosphorus halide for the reaction. In this regard, the hydrogen halide may be hydrogen fluoride, hydrogen chloride, hydrogen bromide, hydrogen iodide, or a mixture thereof. In one embodiment, the hydrogen halide may be hydrogen chloride (HCl). In this regard and without intending to be limited by theory, the present inventors have discovered that efficient removal of the hydrogen halide can allow for the reaction to proceed in an effective manner. For instance, without intending to be limited by theory, such removal may allow for an acceleration in the reaction rate.

In this regard, the present disclosure may also include a step of removing the hydrogen halide. In one embodiment, such removal may begin after the phosphorus halide, in particular all of the phosphorus halide, has been charged. In one embodiment, such removal may begin prior to the reaction temperature reaching the final temperature. For instance, while the temperature of the contents is being increased to a final reaction temperature (e.g., of about 150° C.), the removal of the hydrogen halide may begin using means as disclosed herein. Without intending to be limited by theory, such method may allow for a reduction in the cycle time.

In general, the removal will in one embodiment be conducted in the vessel that is utilized for the reaction. The various methods for removing the hydrogen halide, such as the hydrogen chloride, may include a vacuum, an inert gas sparge, an inert gas sweep, a catalyst, or a combination thereof. In one embodiment, the removal may include an inert gas sparge and a vacuum. For instance, a vacuum may first be utilized; thereafter, the vacuum may be stopped and the inert gas sparge may be conducted. In a further embodiment, the removal may include a vacuum and an inert gas sweep. For instance, a vacuum may first be utilized and then stopped prior to initiating the inert gas sweep; however, it should be understood that such steps may also be reversed. In a further embodiment, the removal may include an inert gas sparge and an inert gas sweep. For instance, an inert gas sweep may be initiated and then stopped prior to initiating an inert gas sparge; however, it should be understood that such steps may also be reversed in one embodiment. In an even further embodiment, the removal may include a vacuum, an inert gas sparge, and an inert gas sweep.

As indicated above, the sparge and/or the sweep may include an inert gas. The inert gas may be one generally utilized in the art and is not necessarily limited. For instance, the inert gas may be a noble gas. The inert gas may be helium in one embodiment. In another embodiment, the inert gas may be nitrogen. In this regard, the aforementioned inert gas sparge may refer to a nitrogen sparge. Similarly, the aforementioned inert gas sweep may refer to a nitrogen sweep.

In one embodiment, the removal may utilize a vacuum. Based on absolute, in one embodiment, the vacuum pressure is less than 760 mmHg, such as 750 mmHg or less, such as 700 mmHg or less, such as 650 mmHg or less, such as 600 mmHg or less, such as 550 mmHg or less, such as 500 mmHg or less, such as 450 mmHg or less, such as 400 mmHg or less, such as 350 mmHg or less, such as 300 mmHg or less, such as 250 mmHg or less, such as 200 mmHg or less, such as 150 mmHg or less, such as 100 mmHg or less, such as 50 mmHg or less. The vacuum pressure may be 0 mmHg or more, such as 25 mmHg or more, such as 50 mmHg or more, such as 100 mmHg or more, such as 150 mmHg or more, such as 200 mmHg or more, such as 250 mmHg or more, such as 300 mmHg or more, such as 350 mmHg or more, such as 400 mmHg or more, such as 450 mmHg or more. Furthermore, when a vacuum is utilized, the final vacuum pressure may be achieved via one or more steps. For instance, the pressure may be reduced to a first reduced pressure and then reduced to a second reduced pressure. The pressure may be maintained at the first reduced pressure for a certain period of time and then at the second reduced pressure for a certain period of time. The period of time maintained at the first reduced pressure may be 2% or more, such as 5% or more, such as 8% or more, such as 10% or more, such as 12% or more, such as 15% or more, such as 20% or more of the total time that vacuum is utilized. The period of time may be 50% or less, such as 40% or less, such as 30% or less, such as 25% or less, such as 20% or less, such as 15% or less, such as 10% or less of the total time that vacuum is utilized. In this regard, such pressure drop may be a step-change decrease rather than a gradual decrease over a period of time to a final vacuum pressure.

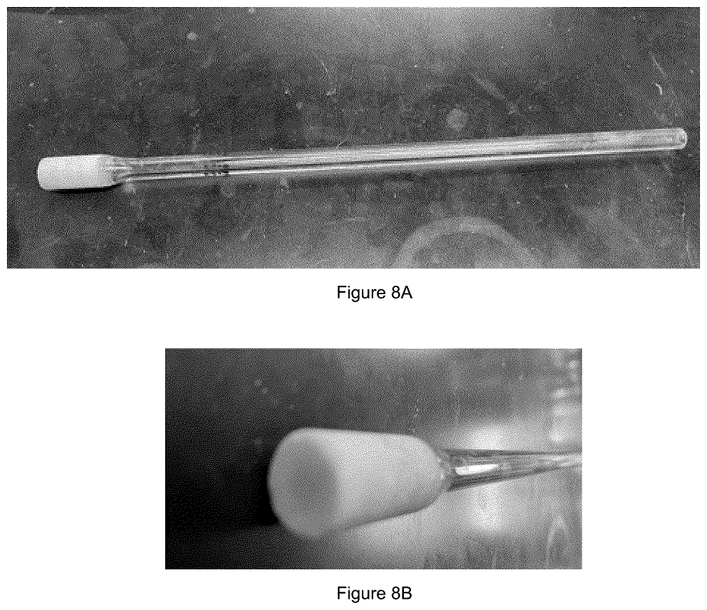

In another embodiment, the removal may utilize an inert gas sparge, such as a nitrogen sparge. In this regard, the sparge is generally a sub-surface sparge wherein the inert gas is introduced into and moves through the reaction medium, which generally comprises the reactants, reagents, and any synthesized by-products/products (product mixture). Just as one example, the nitrogen may be provided using a fritted nitrogen sparge tube (as shown in FIGS. 8A and 8B). In embodiments where nitrogen sweep and nitrogen sparge are used consecutively, the tube may be utilized for one purpose either above surface or sub-surface and then transferred for the other purpose either sub-surface or above surface, respectively. The pressure of the inert gas, such as the nitrogen, is a relatively low pressure. For instance, the pressure may be 1 psi or more, such as 2 psi or more, such as 3 psi or more, such as 5 psi or more, such as 10 psi or more, such as 15 psi or more, such as 20 psi or more, such as 30 psi or more, such as 40 psi or more. The pressure may be 50 psi or less, such as 45 psi or less, such as 40 psi or less, such as 35 psi or less, such as 30 psi or less, such as 25 psi or less, such as 20 psi or less, such as 15 psi or less, such as 10 psi or less, such as 8 psi or less, such as 6 psi or less, such as 4 psi or less, such as 3 psi or less, such as 2 psi or less, such as 1.5 psi or less. The flow rate may be 0.1 L/min or more, such as 0.2 L/min or more, such as 0.3 L/min or more, such as 0.5 L/min or more, such as 0.8 L/min or more, such as 1 L/min or more, such as 1.1 L/min or more, such as 1.3 L/min or more, such as 1.5 L/min or more. The space velocity may be 0.01 s⁻¹ or more, such as 0.05 s⁻¹ or more, such as 0.1 s⁻¹ or more, such as 0.2 s⁻¹ or more, such as 0.3 s⁻¹ or more, such as 0.4 s⁻¹ or more, such as 0.5 s⁻¹ or more, such as 0.7 s⁻¹ or more, such as 0.9 s⁻¹ or more, such as 1 s⁻¹ or more, such as 1.1 s⁻¹ or more, such as 1.3 s⁻¹ or more, such as 1.5 s⁻¹ or more, such as 1.7 s⁻¹ or more, such as 1.9 s⁻¹ or more, such as 2 s⁻¹ or more, such as 3 s⁻¹ or more, such as 5 s⁻¹ or more, such as 10 s⁻¹ or more. The space velocity may be 50 s⁻¹ or less, such as 40 s⁻¹ or less, such as 30 s⁻¹ or less, such as 25 s⁻¹ or less, such as 20 s⁻¹ or less, such as 15 s⁻¹ or less, such as 10 s⁻¹ or less, such as 9 s⁻¹ or less, such as 8 s⁻¹ or less, such as 7 s⁻¹ or less, such as 6 s⁻¹ or less, such as 5 s⁻¹ or less, such as 4 s⁻¹ or less, such as 3 s⁻¹ or less, such as 2 s⁻¹ or less, such as 1.5 s⁻¹ or less, such as 1 s⁻¹ or less, such as 0.8 s⁻¹ or less, such as 0.6 s⁻¹ or less, such as 0.5 s⁻¹ or less, such as 0.4 s⁻¹ or less. The maximum flow rate and/or space velocity may not necessarily be limited so long as the flow does not adversely affect the reaction conditions and vessel contents.

In a further embodiment, the removal may utilize an inert gas sweep, such as a nitrogen sweep. In this regard, the nitrogen sweep is generally an above-surface nitrogen sweep wherein the nitrogen is introduced into and moves generally above the reaction medium, which generally comprises the reactants, reagents, and any synthesized by-products/products (product mixture). The pressure of the inert gas, such as the nitrogen, is a relatively low pressure. For instance, the pressure may be 1 psi or more, such as 2 psi or more, such as 3 psi or more, such as 5 psi or more, such as 10 psi or more, such as 15 psi or more, such as 20 psi or more, such as 30 psi or more, such as 40 psi or more. The pressure may be 50 psi or less, such as 45 psi or less, such as 40 psi or less, such as 35 psi or less, such as 30 psi or less, such as 25 psi or less, such as 20 psi or less, such as 15 psi or less, such as 10 psi or less, such as 8 psi or less, such as 6 psi or less, such as 4 psi or less, such as 3 psi or less, such as 2 psi or less, such as 1.5 psi or less. The flow rate may be 1 m L/min or more, such as 2 mL/min or more, such as 5 mL/min or more, such as 10 mL/min or more, such as 15 mL/min or more, such as 20 mL/min or more, such as 25 mL/min or more, such as 30 mL/min or more, such as 40 mL/min or more, such as 50 mL/min or more, such as 60 mL/min or more, such as 70 mL/min or more, such as 80 mL/min or more, such as 90 mL/min or more. The space velocity may be 0.01 s⁻¹ or more, such as 0.05 s⁻or more, such as 0.1 s⁻¹ or more, such as 0.2 s⁻¹ or more, such as 0.3 s⁻¹ or more, such as 0.4 s⁻¹ or more, such as 0.5 s⁻¹ or more, such as 0.7 s⁻¹ or more, such as 0.9 s⁻¹ or more, such as 1 s⁻¹ or more, such as 1.1 s⁻¹ or more, such as 1.3 s⁻¹ or more, such as 1.5 s⁻¹ or more, such as 1.7 s⁻¹ or more, such as 1.9 s⁻¹ or more, such as 2 s⁻¹ or more, such as 3 s⁻¹ or more, such as 5 s⁻¹ or more, such as 10 s⁻¹ or more. The space velocity may be 50 s⁻¹ or less, such as 40 s⁻¹ or less, such as 30 s⁻¹ or less, such as 25 s⁻¹ or less, such as 20 s⁻¹ or less, such as 15 s⁻¹ or less, such as 10 s⁻¹ or less, such as 9 s⁻¹ or less, such as 8 s⁻¹ or less, such as 7 s⁻¹ or less, such as 6 s⁻¹ or less, such as 5 s⁻¹ or less, such as 4 s⁻¹ or less, such as 3 s⁻¹ or less, such as 2 s⁻¹ or less, such as 1.5 s⁻¹ or less, such as 1 s⁻¹ or less, such as 0.8 s⁻¹ or less, such as 0.6 s⁻¹ or less, such as 0.5 s⁻¹ or less, such as 0.4 s⁻¹ or less. The maximum flow rate may not necessarily be limited so long as the flow does not adversely affect the reaction conditions and vessel contents.

In a further embodiment, the removal may utilize a catalyst. For instance, the catalyst may be a base catalyst. The catalyst may react with the hydrogen halide to form an amine salt. In this regard, the base catalyst may be a nitrogen containing catalyst. In addition to removing the hydrogen halide, the catalyst may also assist with accelerating the reaction rate.

The catalyst may include an alkylamine, a nitrogen-containing heterocyclic compound, or a mixture thereof. In one embodiment, the catalyst may include an alkylamine, such as a monoalkylamine, a dialkylamine, a trialkylamine, or a mixture thereof. In one embodiment, the alkylamine may include a monoalkylamine. In another embodiment, the alkylamine may include a dialkylamine. In a further embodiment, the alkylamine may include a trialkylamine. The alkylamine may include triethylamine, dimethyldodecylamine, dimethyl laurylamine, n-methyl octadecylamine, dibutylamine, etc. as well as mixtures thereof. In one embodiment, the alkylamine may include triethylamine.

Also, the amine may include a nitrogen-containing heterocyclic compound, such as a saturated heterocyclic compound and/or an unsaturated heterocyclic compound. The compound may include a pyrrolidine, a pyrrole, an imidazolidine, a pyrazolidine, a triazole, a tetrazole, a piperidine, a pyridine, a triazine, etc. as well as mixtures thereof. In one embodiment, the compound may include a pyrrolidine, such as N-methyl pyrrolidine. In addition, the nitrogen-containing heterocyclic compound may include a fused or condensed ring. For instance, this may include compounds having 7 or more, such as 8 or more, such as 9 or more atoms within the internal ring structure, including at least one nitrogen. This may include compounds having 12 or less, such as 11 or less, such as 10 or less, such as 9 or less atoms within the internal ring structure, including at least one nitrogen. As one example, the amine including a fused heterocyclic ring may include a diazabicycloundecene.

The aforementioned removal of the hydrogen halide may be conducted while the reaction is in progress. In this regard, it may be conducted while the phosphorus halide is being introduced. In another embodiment, the removal may begin after the phosphorus halide has been introduced, such as entirely introduced to the vessel. Furthermore, the removal, such as by the use of the inert gas sparge, may be for a certain period of time. For instance, the time may be about 0.1 hours or more, such as about 0.2 hours or more, such as about hours or more, such as about 1 hour or more, such as about 1.5 hours or more, such as about 2 hours or more, such as about 3 hours or more, such as about 4 hours or more, such as about 5 hours or more. The time may be about 10 hours or less, such as about 8 hours or less, such as about 6 hours or less, such as about 5 hours or less, such as about 4 hours or less, such as about 3 hours or less, such as about 2 hours or less, such as about 1.5 hours or less, such as about 1 hour or less, such as about 0.8 hours or less, such as about 0.5 hours or less.

As indicated above, the removal of the hydrogen halide may begin prior to the reaction temperature reaching the final temperature. In this regard, such removal may begin at a temperature of about 150° C. or less, such as about 140° C. or less, such as about 130° C. or less, such as about 120° C. or less, such as about 110° C. or less, such as about 100° C. or less, such as about 90° C. or less, such as about 80° C. or less, such as about 70° C. or less, such as about 60° C. or less. For instance, the temperature may be about 20° C. or more, such as about 25° C. or more, such as about 30° C. or more, such as about 40° C. or more, such as about 50° C. or more, such as about 60° C. or more, such as about 70° C. or more, such as about 80° C. or more, such as about 90° C. or more.

Once the reaction has been completed and the hydrogen halide has been removed, the hydrogen halide may be processed using means known in the art. In addition, after removal of the hydrogen halide from the vessel, the reaction product may be allowed to cool. Thereafter, the reaction product may be stored. It may be stored in an inert atmosphere. For instance, the inert gas for storage may be one as disclosed herein.

The method as disclosed herein may also have a relatively low cycle time. In general, the cycle time may be defined from the time at which the hydroxyl-substituted compound is introduced to the time at which the product is discharged from the reaction vessel. For instance, the cycle time may be about about 15 hours or less, such as about 14 hours or less, such as about 13 hours or less, such as about 12 hours or less, such as about 11 hours or less, such as about 10 hours or less, such as about 9 hours or less, such as about 8 hours or less, such as about 7 hours or less, such as about 6 hours or less, such as about 5 hours or less, such as about 4 hours or less, such as about 3 hours or less, such as about 2 hours or less. The cycle time may be about 0.5 hours or more, such as about 1 hour or more, such as about 2 hours or more, such as about 3 hours or more, such as about 4 hours or more, such as about 5 hours or more, such as about 6 hours or more, such as about 7 hours or more, such as about 8 hours or more, such as about 9 hours or more, such as about 10 hours or more, such as about 11 hours or more, such as about 12 hours or more.

In addition, regarding the reaction, it may be determined to be completed based on the residual amount of the hydroxyl-substituted compound remaining. For instance, it may be determined that the reaction has been completed when the hydroxyl-substituted compound is present in an amount of about 5 wt. % or less, such as about 4 wt. % or less, such as about 3 wt. % or less, such as about 2.5 wt. % or less, such as about 2 wt. % or less, such as about 1.5 wt. % or less.

As indicated above, the reaction results in a product mixture comprising a reaction product. The reaction product comprises a phosphite ester. In general, the phosphite ester may have the following structure:

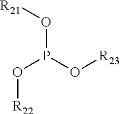

wherein
R₂₁, R₂₂, and R₂₃ are each independently an alkyl or an aryl.

In one embodiment, at least one of R_{21,} R₂₂, and R₂₃ may be alkyl. In another embodiment, at least two of R₂₁, R₂₂, and R₂₃ may be alkyl. In a further embodiment, all three of R₂₁, R₂₂, and R₂₃ may be alkyl. In one embodiment, the alkyl may be an unsubstituted alkyl. In another embodiment, the alkyl may be a substituted alkyl. For instance, the alkyl may be an arylkyl (i.e., an alkyl substituted with an aryl group).

For instance, the alkyl may be a C₁-C₁₀ alkyl. In this regard, the alkyl may be a C₁-C₁₀ alkyl, such as a C₁-C₈ alkyl, such as a C₁-C₆ alkyl, such as a C₁-C₄ alkyl, such as a C₁-C₃ alkyl, such as a Ci-C₂ alkyl, such as a C₁ alkyl. For instance, the alkyl may have 1 or more, such as 2 or more, such as 3 or more, such as 4 or more, such as 5 or more carbon atoms. The alkyl may have 10 or less, such as 8 or less, such as 6 or less, such as 5 or less, such as 4 or less, such as 3 or less, such as 2 or less carbon atoms. In this regard, the alkyl may be heptyl, hexyl, pentyl (e.g., n-pentyl, sec-pentyl, iso-pentyl, tert-pentyl, neo-pentyl), butyl (e.g., n-butyl, sec-butyl, iso-butyl, tert-butyl), propyl (e.g., n-propyl, iso-propyl), ethyl, methyl, etc. In one particular embodiment, the alkyl may be methyl. In addition, the alkyl may be a straight chain, a branched chain, or cyclic. In one embodiment, the alkyl is a straight chain. In another embodiment, the alkyl is a branched chain. In a further embodiment, the alkyl is cyclic (or cycloalkyl).

Regarding the substituted alkyl, it may be an arylkyl (i.e., an alkyl substituted with an aryl group) in one embodiment. The aryl may be a C₃-C₁₂ aryl. In this regard, the aryl may be a C₃-C₁₂ aryl, such as a C₄-C₁₂ aryl, such as a C₆-C₁₂ aryl, such as a C₆-C₁₀ aryl, such as a C₆-C₈ aryl, such as a C₆ aryl. For instance, the aryl may have 3 or more, such as 4 or more, such as 5 or more, such as 6 or more carbon atoms. The aryl may have 12 or less, such as 10 or less, such as 8 or less, such as 7 or less, such as 6 or less, such as 5 or less carbon atoms. In one particular embodiment, the aryl may be a phenyl. In addition, in one embodiment, the aryl may be polycyclic. The polycyclic aryl may include fused, bridged, and spiro ring systems.

In one embodiment, at least one of R₂₁, R₂₂, and R₂₃ may be aryl. In another embodiment, at least two of R₂₁, R₂₂, and R₂₃ may be aryl. In a further embodiment, all three of R₂₁, R₂₂, and R₂₃ may be aryl. In one embodiment, the aryl may be an unsubstituted aryl. In another embodiment, the aryl may be a substituted aryl. For instance, the aryl may be an alkaryl (i.e., an aryl substituted with an alkyl group).

For instance, the aryl may be a C₃-C₁₂ aryl. In this regard, the aryl may be a C₃-C₁₂ aryl, such as a C₄-C₁₂ aryl, such as a C₆-C₁₂ aryl, such as a C₆-C₁₀ aryl, such as a C₆-C₈ aryl, such as a C6 aryl. For instance, the aryl may have 3 or more, such as 4 or more, such as 5 or more, such as 6 or more carbon atoms. The aryl may have 12 or less, such as 10 or less, such as 8 or less, such as 7 or less, such as 6 or less, such as 5 or less carbon atoms. In one particular embodiment, the aryl may be a phenyl. In addition, in one embodiment, the aryl may be polycyclic. The polycyclic aryl may include fused, bridged, and spiro ring systems.

Regarding the substituted aryl, it may be an alkaryl (i.e., an aryl substituted with an alkyl group). The alkyl may be a C₁-C₁₀ alkyl. In this regard, the alkyl may be a C₁-C₁₀ alkyl, such as a C₁-C₈ alkyl, such as a C₁-C₆ alkyl, such as a C₁-C₄ alkyl, such as a C₁-C₃ alkyl, such as a C₁-C₂ alkyl, such as a C₁ alkyl. For instance, the alkyl may have 1 or more, such as 2 or more, such as 3 or more, such as 4 or more, such as 5 or more carbon atoms. The alkyl may have 10 or less, such as 8 or less, such as 6 or less, such as 5 or less, such as 4 or less, such as 3 or less, such as 2 or less carbon atoms. In this regard, the alkyl may be heptyl, hexyl, pentyl (e.g., n-pentyl, sec-pentyl, iso-pentyl, tert-pentyl, neo-pentyl), butyl (e.g., n-butyl, sec-butyl, iso-butyl, tert-butyl), propyl (e.g., n-propyl, iso-propyl), ethyl, methyl, etc. In one particular embodiment, the alkyl may be methyl. In addition, the alkyl may be a straight chain, a branched chain, or cyclic. In one embodiment, the alkyl is a straight chain. In another embodiment, the alkyl is a branched chain. In a further embodiment, the alkyl is cyclic (or cycloalkyl).

In this regard, in one embodiment, the phosphite ester may be a trialkyl phosphite. In another embodiment, the phosphite ester may be a triaryl phosphite. In a further embodiment, the phosphite ester may be a dialkyl monoaryl phosphite. In an even further embodiment, the phosphite ester may be a diaryl monoalkyl phosphite.

In particular, when R₂₁, R₂₂, and R₂₃ are aryl (e.g., alkaryl), the phosphite ester may have the following structure:

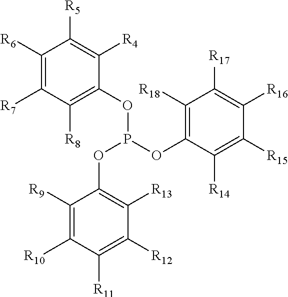

wherein
R₄, R₅, R₆, R₇, R₈, R₉, R₁₀, R₁₁, R₁₂, R₁₃, R₁₄, R₁₅, R₁₆, R₁₇, and R₁₈ are independently hydrogen or an alkyl.

In this regard, in one embodiment, the substituent groups of the aforementioned structure may all be hydrogen. However, as indicated above, the substituent groups may independently be an alkyl. The alkyl may correspond to those mentioned herein. For instance, the alkyl may be a C₁-C₁₀ alkyl. In this regard, the alkyl may be a C₁-C₁₀ alkyl, such as a C₁-C₈ alkyl, such as a C₁-C₆ alkyl, such as a C₁-C₄ alkyl, such as a C₁-C₃ alkyl, such as a C₁-C₂ alkyl, such as a C₁ alkyl. For instance, the alkyl may have 1 or more, such as 2 or more, such as 3 or more, such as 4 or more, such as 5 or more carbon atoms. The alkyl may have 10 or less, such as 8 or less, such as 6 or less, such as 5 or less, such as 4 or less, such as 3 or less, such as 2 or less carbon atoms. In this regard, the alkyl may be heptyl, hexyl, pentyl (e.g., n-pentyl, sec-pentyl, iso-pentyl, tert-pentyl, neo-pentyl), butyl (e.g., n-butyl, sec-butyl, iso-butyl, tert-butyl), propyl (e.g., n-propyl, iso-propyl), ethyl, methyl, etc. In one particular embodiment, the alkyl may be methyl. In addition, the alkyl may be a straight chain, a branched chain, or cyclic. In one embodiment, the alkyl is a straight chain. In another embodiment, the alkyl is a branched chain. In a further embodiment, the alkyl is cyclic (or cycloalkyl).

Furthermore, a respective aryl group may have at least one alkyl substitution. In this regard, at least one, such as at least two, such as all three of the aryl groups may have at least one alkyl substitution. Accordingly, in one embodiment, at least one of R₄, R₅, R₆, R₇, and R₈ may be an alkyl. In one embodiment, at least one of R₉, R₁₀, R₁₁, R₁₂, and R₁₃ may be an alkyl. In one embodiment, at least one of R₁₄, R₁₅, R₁₆, R₁₇, and R₁₈ may be an alkyl. In this regard, at least one of R₄, R₅, R₆, R₇, and R₈, at least one of R₉, R₁₀, R₁₁, R₁₂, and R₁₃, and at least one of R₁₄, R₁₅, R₁₆, R₁₇, and R₁₈ may be an alkyl, such as a C₁-C₄ alkyl, such as a methyl.

As indicated herein, the hydroxyl-substituted compound utilized in making the phosphite ester may be p-cresol. In this regard, at least one of R₆, R₁₁, and R₁₆ may be an alkyl, such as a C₁-C₄ alkyl, such as methyl. In one embodiment, at least two of R₆, R₁₁, and R₁₆ may be an alkyl, such as a C₁-C₄ alkyl, such as methyl. In a further embodiment, R₆, R₁₁, and R₁₆ are each an alkyl, such as a C₁-C₄ alkyl, such as methyl. In such embodiments, the remaining substituent groups may independently be hydrogen.

Also as indicated herein, the hydroxyl-substituted compound utilized in making the phosphite ester may be m-cresol. In this regard, at least one of R₅ and R₇ may be an alkyl, such as a C₁-C₄ alkyl, such as methyl. In one embodiment, at least one of R₁₀ and R₁₂ may be an alkyl, such as a C₁-C₄ alkyl, such as methyl. In a further embodiment, at least one of R₁₅ and R₁₇ may be an alkyl, such as a C₁-C₄ alkyl, such as methyl. Accordingly, at least one of R₅ and R₇, at least one of R₁₀ and R₁₂, and at least one of R₁₅ and R₁₇ may be an alkyl, such as a C₁-C₄ alkyl, such as methyl. In such embodiments, the remaining substituent groups may independently be hydrogen.

In addition, as indicated herein, the hydroxyl-substituted compound utilized in making the phosphite ester may be m-cresol, p-cresol, or a mixture thereof. In this regard, at least one of R₅, R₆, and R₇ may be an alkyl, such as a C₁-C₄ alkyl, such as methyl. Similarly, at least one of R₁₀, R₁₁, and R₁₂ may be an alkyl, such as a C₁-C₄ alkyl, such as methyl. In addition, at least one of R₁₅, R₁₆, and R₁₇ may be an alkyl, such as a C₁-C₄ alkyl, such as methyl. Accordingly, at least one of R₅, R₆, and R₇, at least one of R₁₀, R₁₁, and R₁₂, and at least one of R₁₅, R₁₆, and R₁₇ may be an alkyl, such as a C₁-C₄ alkyl, such as methyl. In such embodiments, the remaining substituent groups may independently be hydrogen.

While the aforementioned structures are utilized to depict the phosphite ester, in view of such structures, it should be understood that multiple phosphite esters may be manufactured so long as they satisfy the structure and corresponding definitions. In this regard, the reaction product may include a mixture of phosphite esters, for example having the aforementioned structure.

Generally, in one embodiment, the phosphite ester may include a compound having the following structure:

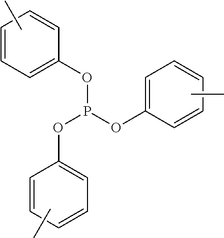

In particular, when utilizing a hydroxyl-substituted compound comprising p-cresol, the phosphite ester may include a compound having the following structure:

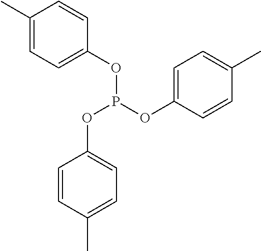

As indicated above, the reaction product comprises the phosphite ester. However, the reaction product may also include one or more compounds of structure (I). In this regard, the reaction product may also include a phosphohalodite. In this regard, in one embodiment, the reaction product comprises a phosphite ester and a phosphohalodite.

Regarding the phosphohalodite, the compound may be based on the particular type of phosphorus halide utilized in the reaction. For instance, when the phosphorus halide is a phosphorus chloride, such as a phosphorus trichloride, the phosphohalodite may be a phosphochlorodite.

In this regard, the reaction product may include a compound having the following structure (I):

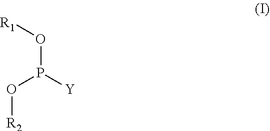

wherein
R₁ is an alkyl or an aryl;
R₂ is an alkyl or an aryl;
Y is -Z; and
Z is a halide.

As indicated above, Z is a halide. The halide may be a fluoride, a chloride, a bromide, an iodide, or a mixture thereof. In one embodiment, the halide may be a chloride.

As indicated above, R₁ and R₂ are each independently an alkyl or an aryl. In one embodiment, one or both may be an alkyl. In another embodiment, one or both may be an aryl. Furthermore, in one embodiment, R₁ and R₂ may correspond to R₂₁ and R₂₂ above.

In one embodiment, at least one of R₁ and R₂ may be alkyl. In another embodiment, both R₁ and R₂ may be alkyl. In one embodiment, the alkyl may be an unsubstituted alkyl. In another embodiment, the alkyl may be a substituted alkyl. For instance, the alkyl may be an arylkyl (i.e., an alkyl substituted with an aryl group).

For instance, the alkyl may be a C₁-C₁₀ alkyl. In this regard, the alkyl may be a C₁-C₁₀ alkyl, such as a C₁-C₈ alkyl, such as a C₁-C₆ alkyl, such as a C₁-C₄ alkyl, such as a C₁-C₃ alkyl, such as a C₁-C₂ alkyl, such as a C₁ alkyl. For instance, the alkyl may have 1 or more, such as 2 or more, such as 3 or more, such as 4 or more, such as 5 or more carbon atoms. The alkyl may have 10 or less, such as 8 or less, such as 6 or less, such as 5 or less, such as 4 or less, such as 3 or less, such as 2 or less carbon atoms. In this regard, the alkyl may be heptyl, hexyl, pentyl (e.g., n-pentyl, sec-pentyl, iso-pentyl, tert-pentyl, neo-pentyl), butyl (e.g., n-butyl, sec-butyl, iso-butyl, tert-butyl), propyl (e.g., n-propyl, iso-propyl), ethyl, methyl, etc. In one particular embodiment, the alkyl may be methyl. In addition, the alkyl may be a straight chain, a branched chain, or cyclic. In one embodiment, the alkyl is a straight chain. In another embodiment, the alkyl is a branched chain. In a further embodiment, the alkyl is cyclic (or cycloalkyl).

Regarding the substituted alkyl, it may be an arylkyl (i.e., an alkyl substituted with an aryl group) in one embodiment. The aryl may be a C₃-C₁₂ aryl. In this regard, the aryl may be a C₃-C₁₂ aryl, such as a C₄-C₁₂ aryl, such as a C₆-C₁₂ aryl, such as a C₆-C₁₀ aryl, such as a C₆-C₈ aryl, such as a C₆ aryl. For instance, the aryl may have 3 or more, such as 4 or more, such as 5 or more, such as 6 or more carbon atoms. The aryl may have 12 or less, such as 10 or less, such as 8 or less, such as 7 or less, such as 6 or less, such as 5 or less carbon atoms. In one particular embodiment, the aryl may be a phenyl. In addition, in one embodiment, the aryl may be polycyclic. The polycyclic aryl may include fused, bridged, and spiro ring systems.

In one embodiment, at least one of R₁ and R₂ may be aryl. In another embodiment, both R₁ and R₂ may be aryl. In one embodiment, the aryl may be an unsubstituted aryl. In another embodiment, the aryl may be a substituted aryl. For instance, the aryl may be an alkaryl (i.e., an aryl substituted with an alkyl group).

For instance, the aryl may be a C₃-C₁₂ aryl. In this regard, the aryl may be a C₃-C₁₂ aryl, such as a C₄-C₁₂ aryl, such as a C₆-C₁₂ aryl, such as a C₆-C₁₀ aryl, such as a C₆-C₈ aryl, such as a C₆ aryl. For instance, the aryl may have 3 or more, such as 4 or more, such as 5 or more, such as 6 or more carbon atoms. The aryl may have 12 or less, such as 10 or less, such as 8 or less, such as 7 or less, such as 6 or less, such as 5 or less carbon atoms. In one particular embodiment, the aryl may be a phenyl. In addition, in one embodiment, the aryl may be polycyclic. The polycyclic aryl may include fused, bridged, and spiro ring systems.

Regarding the substituted aryl, it may be an alkaryl (i.e., an aryl substituted with an alkyl group). The alkyl may be a C₁-C₁₀ alkyl. In this regard, the alkyl may be a C₁-C₁₀ alkyl, such as a C₁-C₈ alkyl, such as a C₁-C₆ alkyl, such as a C₁-C₄ alkyl, such as a C₁-C₃ alkyl, such as a C₁-C₂ alkyl, such as a C₁ alkyl. For instance, the alkyl may have 1 or more, such as 2 or more, such as 3 or more, such as 4 or more, such as 5 or more carbon atoms. The alkyl may have 10 or less, such as 8 or less, such as 6 or less, such as 5 or less, such as 4 or less, such as 3 or less, such as 2 or less carbon atoms. In this regard, the alkyl may be heptyl, hexyl, pentyl (e.g., n-pentyl, sec-pentyl, iso-pentyl, tert-pentyl, neo-pentyl), butyl (e.g., n-butyl, sec-butyl, iso-butyl, tert-butyl), propyl (e.g., n-propyl, iso-propyl), ethyl, methyl, etc. In one particular embodiment, the alkyl may be methyl. In addition, the alkyl may be a straight chain, a branched chain, or cyclic. In one embodiment, the alkyl is a straight chain. In another embodiment, the alkyl is a branched chain. In a further embodiment, the alkyl is cyclic (or cycloalkyl).

When R₁ is an aryl, the aforementioned compound may have the following structure:

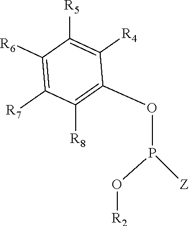

wherein
R₂, R₄, R₅, R₆, R₇, R₈, and Z are as defined above.

In particular, the aforementioned compound may have the following structure wherein the aryl group includes an alkyl substitution, in particular a methyl substitution:

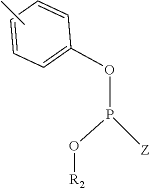

wherein
R₂ and Z are as defined above.

When R₁ and R₂ are an aryl group, the aforementioned compound may have the following structure:

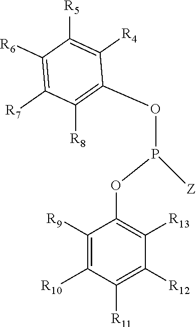

wherein
R₄, R₅, R₆, R₇, R₈, R₉, R₁₀, R₁₁, R₁₂, R₁₃, and Z are as defined above.

In particular, the aforementioned compound may have the following structure wherein the aryl groups include an alkyl substitution, in particular a methyl substitution:

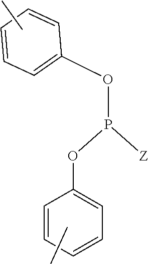

wherein
Z is as defined above.

While the aforementioned structures are utilized to depict the additional compounds in the reaction product, such as the phosphohalodite(s), in view of such structures, it should be understood that multiple compounds may be manufactured so long as they satisfy the structure and corresponding definitions. In this regard, the reaction product may include a mixture of phosphohalodites, for example having the aforementioned structure.

As indicated above, the product mixture comprises a hydrogen halide and a reaction product comprising the phosphite ester. The reaction product may also include a phosphohalodite. The purity of the phosphite ester may be relatively high.

Furthermore, as generally understood in the art, the phosphohalodites will include at least one halide, such as a chloride, directly bonded to the central phosphorus atom.

Based on the reaction product, the purity of the phosphite ester may be about 70% or more, such as about 75% or more, such as about 80% or more, such as about 85% or more, such as about 88% or more, such as about 90% or more. Furthermore, the phosphite ester may be present in an amount of about 100 wt. % or less, such as about 99 wt. % or less, such as about 98 wt. % or less, such as about 97 wt. % or less, such as about 95 wt. % or less, such as about 93 wt. % or less, such as about 90 wt. % or less. In one embodiment, such purity may be based on a mole %. In another embodiment, such purity may be based on a weight %. For the sake of clarity, such purity may be based on the combination of the phosphite ester and the phosphohalodite.

The phosphite ester may be present in an amount of about 75 wt. % or more, such as about 78 wt. % or more, such as about 80 wt. % or more, such as about 82 wt. % or more, such as about 84 wt. % or more, such as about 86 wt. % or more, such as about 88 wt. % or more, such as about 90 wt. % or more, such as about 92 wt. % or more, such as about 94 wt. % or more, such as about 95 wt. % or more, such as about 96 wt. % or more, such as about 97 wt. % or more, such as about 98 wt. % or more based on the weight of the reaction product. The phosphite ester may be present in an amount of about 100 wt. % or less, such as about 98 wt. % or less, such as about 96 wt. % or less, such as about 94 wt. % or less, such as about 92 wt. % or less, such as about 90 wt. % or less based on the weight of the reaction product.

The one or more compounds of structure (I) may be present in an amount of about 0.1 wt. % or more, such as about 0.3 wt. % or more, such as about 0.5 wt. % or more, such as about 1 wt. % or more, such as about 2 wt. % or more, such as about 3 wt. % or more, such as about 4 wt. % or more, such as about 5 wt. % or more, such as about 6 wt. % or more, such as about 7 wt. % or more based on the total weight of the reaction product. The one or more compounds of structure (I) may be present in an amount of about 20 wt. % or less, such as about 15 wt. % or less, such as about 12 wt. % or less, such as about 11 wt. % or less, such as about 10 wt. % or less, such as about 9 wt. % or less, such as about 8 wt. % or less, such as about 7 wt. % or less, such as about 6 wt. % or less, such as about 5 wt. % or less, such as about 4 wt. % or less, such as about 3 wt. % or less, such as about 2 wt. % or less, such as about 1 wt. % or less, such as about 0.5 wt. % or less based on the total weight of the reaction product. For instance, the one or more compounds of structure (I) may be present in an amount of from about 0.3 wt. % to about 15 wt. %, such as from about 0.5 wt. % to about 15 wt. %, such as from about 1 wt. % to about 12 wt. %, such as from about 2 wt. % to about 12 wt. %, such as from about 5 wt. % to about 10 wt. %, such as from about 7 wt. % to about 10 wt. % based on the total weight of the reaction product. In another embodiment, the one or more compounds of structure (I) may be present in an amount of from about 0.3 wt. % to about 15 wt. %, such as from about 0.5 wt. % to about 15 wt. %, such as from about 1 wt. % to about 10 wt. %, such as from about 1 wt. % to about 8 wt. %, such as from about 1 wt. % to about 6 wt. %, such as from about 2 wt. % to about 5 wt. %, such as from about 2 wt. % to about 4 wt. % based on the total weight of the reaction product. As indicated herein, the one or more compounds of structure (I) may be a phosphohalodite. Furthermore, such aforementioned weight percentages may apply to any single compound of structure (I) in one embodiment or collectively to the one or more compounds of structure (I) in another embodiment.

The phosphohalodite(s) may be present in an amount of about 0.1 wt. % or more, such as about 0.5 wt. % or more, such as about 1 wt. % or more, such as about 2 wt. % or more, such as about 3 wt. % or more, such as about 4 wt. % or more, such as about 5 wt. % or more, such as about 6 wt. % or more, such as about 7 wt. % or more based on the total weight of the reaction product. The phosphohalodite(s) may be present in an amount of about 20 wt. % or less, such as about 15 wt. % or less, such as about 12 wt. % or less, such as about 11 wt. % or less, such as about 10 wt. % or less, such as about 9 wt. % or less, such as about 8 wt. % or less, such as about 7 wt. % or less, such as about 6 wt. % or less, such as about 5 wt. % or less, such as about 4 wt. % or less, such as about 3 wt. % or less, such as about 2 wt. % or less, such as about 1 wt. % or less, such as about 0.5 wt. % or less based on the total weight of the reaction product. For instance, the phosphohalodite(s) may be present in an amount of from about 0.5 wt. % to about 15 wt. %, such as from 1 wt. % to about 12 wt. %, such as from about 2 wt. % to about 12 wt. %, such as from about 5 wt. % to about 12 wt. % or from about 5 wt. % to about 10 wt. %, such as from about 7 wt. % to about 12 wt. % or from about 7 wt. % to about 10 wt. % based on the total weight of the reaction product. In another embodiment, the phosphohalodite(s) may be present in an amount of from about 0.5 wt. % to about 15 wt. %, such as from about 1 wt. % to about 10 wt. %, such as from about 1 wt. % to about 8 wt. %, such as from about 1 wt. % to about 6 wt. %, such as from about 2 wt. % to about 5 wt. %, such as from about 2 wt. % to about 4 wt. % based on the total weight of the reaction product.

The phosphite ester and phosphohalodites combined may be present in an amount of about 75 wt. % or more, such as about 78 wt. % or more, such as about 80 wt. % or more, such as about 82 wt. % or more, such as about 84 wt. % or more, such as about 86 wt. % or more, such as about 88 wt. % or more, such as about 90 wt. % or more, such as about 92 wt. % or more, such as about 94 wt. % or more, such as about 95 wt. % or more, such as about 96 wt. % or more, such as about 97 wt. % or more, such as about 98 wt. % or more based on the weight of the reaction product. The phosphite ester and phosphohalodites combined may be present in an amount of about 100 wt. % or less, such as about 98 wt. % or less, such as about 96 wt. % or less, such as about 94 wt. % or less, such as about 92 wt. % or less, such as about 90 wt. % or less based on the weight of the reaction product.

In some embodiments of the present disclosure, phosphohalodite(s) are desired reaction products in addition to the one or more phosphite ester and one or more hydrogen halide. Advantageously, by controlling the stoichiometric ratio of p-cresol to m-cresol to phosphorous trichloride, cycle time, temperature, nitrogen sparge, nitrogen sweep, and/or vacuum, the level of total chlorides in the product can be controlled and predetermined by controlling the amount of phosphohalodites in addition to the amount of hydrogen halide.

In addition or in lieu of the aforementioned phosphohalodite, the reaction product may include a phosphite ester hydrolysis product. In this regard, as also indicated above, Y may be —O—H. Without intending to be limited by theory, a hydrolysis reaction may have occurred cleaving the corresponding R group or halide and substituting for hydrogen. In general, one example of such a product may have a structure as follows:

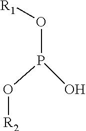

wherein
R₁ and R₂ are as defined above.

In particular, the product may have a structure as follows wherein R₁ and R₂ are each aryl:

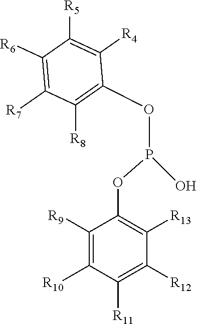

wherein
R₄, R₅, R₆, R₇, R₈, R₉, R₁₀, R₁₁, R₁₂, and R₁₃ are as defined above.

While the aforementioned structures are utilized to depict the additional compounds in the reaction product, such as the phosphite ester hydrolysis product, in view of such structures, it should be understood that multiple compounds may be manufactured so long as they satisfy the structure and corresponding definitions. In this regard, the reaction product may include a mixture of phosphite ester hydrolysis products, for example having the aforementioned structure.

In this regard, the reaction product as disclosed herein may comprise a phosphite ester hydrolysis product in addition to the phosphite ester and if present, the phosphohalodite. Such phosphite ester hydrolysis product may be a hydrolysis product of the phosphite ester synthesized in accordance with the present disclosure. However, it may be desired to minimize the concentration of the phosphite ester hydrolysis product in the reaction product. In this regard, the amount of the phosphite ester hydrolysis product may be about 5 wt. % or less, such as about 4 wt. % or less, such as about 3 wt. % or less, such as about 2.5 wt. % or less, such as about 2 wt. % or less, such as about 1.8 wt. % or less, such as about 1.5 wt. % or less, such as about 1.3 wt. % or less, such as about 1.1 wt. % or less, such as about 1 wt. % or less, such as about 0.8 wt. % or less, such as about 0.5 wt. % or less, such as about 0.3 wt. % or less. The amount of the phosphite ester hydrolysis product may be 0 wt. % or more, such as about 0.1 wt. % or more, such as about 0.3 wt. % or more, such as about 0.5 wt. % or more, such as about 0.8 wt. % or more, such as about 1 wt. % or more, such as about 1.3 wt. % or more.

The amount of the phosphite ester hydrolysis product may be controlled depending on the moisture content, in particular of the initial reactants. For instance, the moisture content may be about 2,000 ppm or less, such as about 1,800 ppm or less, such as about 1,500 ppm or less, such as about 1,300 ppm or less, such as about 1,000 ppm or less, such as about 800 ppm or less, such as about 600 ppm or less, such as about 500 ppm or less, such as about 400 ppm or less, such as about 300 ppm or less, such as about 200 ppm or less, such as about 100 ppm or less based on the reactants. The moisture content may be about 1 ppm or more, such as about 5 ppm or more, such as about 10 ppm or more, such as about 50 ppm or more, such as about 100 ppm or more, such as about 200 ppm or more, such as about 300 ppm or more, such as about 400 ppm or more based on the reactants. In particular, the moisture content may be about 1,500 ppm or less, such as about 1,300 ppm or less, such as about 1,000 ppm or less, such as about 800 ppm or less, such as about 600 ppm or less, such as about 500 ppm or less, such as about 400 ppm or less, such as about 300 ppm or less, such as about 200 ppm or less, such as about 100 ppm or less based on the hydroxyl-substituted compound. The moisture content may be about 1 ppm or more, such as about 5 ppm or more, such as about 10 ppm or more, such as about 50 ppm or more, such as about 100 ppm or more, such as about 200 ppm or more, such as about 300 ppm or more, such as about 400 ppm or more based on the hydroxyl-substituted compound.

The reaction product may include a certain halide content, such as chloride content. In particular, the present reaction may be controlled in a manner to obtain a certain halide content, such as a chloride content. For instance, in one embodiment, it may be desired to have a relatively high halide content, such as from about 10,000 ppm to about 15,000ppm. In another embodiment, it may be desired to have a relatively low halide content, such as less than about 10,000 ppm and in particular from about 3,000 ppm to about 5,000 ppm.

Regardless, the halide content, such as the chloride content, may be about 50 ppm or more, such as about 100 ppm or more, such as about 200 ppm or more, such as about 300 ppm or more, such as about 500 ppm or more, such as about 1,000 ppm or more, such as about 2,000 ppm or more, such as about 3,000 ppm or more, such as about 5,000 ppm or more, such as about 7,000 ppm or more, such as about 9,000 ppm or more, such as about 10,000 ppm or more, such as about 11,000 ppm or more, such as about 12,000 ppm or more, such as about 13,000 ppm or more, such as about 15,000 ppm or more. The halide content, such as the chloride content, may be about 25,000 ppm or less, such as about 23,000 ppm or less, such as about 21,000 ppm or less, such as about 20,000 ppm or less, such as about 18,000 ppm or less, such as about 17,000 ppm or less, such as about 16,000 ppm or less, such as about 15,000 ppm or less, such as about 14,00 ppm or less, such as about 13,000 ppm or less, such as about 12,000 ppm or less, such as about 11,000 ppm or less, such as about 10,000 ppm or less, such as about 8,000 ppm or less, such as about 6,000 ppm or less, such as about 5,000 ppm or less.

Furthermore, in one embodiment, the reaction product may not include phenol (i.e., unsubstituted phenol - one having only a hydroxyl substitution). In this regard, the reaction product may include about 2 wt. % or less, such as about 1.8 wt. % or less, such as about 1.5 wt. % or less, such as about 1.3 wt. % or less, such as about 1 wt. % or less, such as about 0.8 wt. % or less, such as about 0.5 wt. % or less, such as about 0.3 wt. % or less, such as about 0.2 wt. % or less, such as about 0.1 wt. % or less, such as about 0.05 wt. % or less, such as about 0 wt. % of phenol. However, for the sake of clarity, the reaction product may still include substituted phenols, such as cresols or xylenols. If included, they may be present in an amount of about 15 wt. % or less, such as about 10 wt. % or less, such as about 8 wt. % or less, such as about 6 wt. % or less, such as about 4 wt. % or less, such as about 2 wt. % or less, such as about 1.8 wt. % or less, such as about 1.5 wt. % or less, such as about 1.3 wt. % or less, such as about 1 wt. % or less, such as about 0.8 wt. % or less, such as about 0.5 wt. % or less, such as about 0.2 wt. % or less. If present, the reaction product may include substituted phenols in an amount of greater than 0 wt. %, such as about 0.1 wt. % or more, such as about 0.2 wt. % or more, such as about 0.3 wt. % or more, such as about 0.4 wt. % or more, such as about 0.5 wt. % or more, such as about 0.6 wt. % or more, such as about 1 wt. % or more, such as about 1.5 wt. % or more, such as about 2 wt. % or more. Similarly, in another embodiment, the reaction product may include phenol (i.e., unsubstituted phenol - one having only a hydroxyl substitution in an amount of about 15 wt. % or less, such as about 10 wt. % or less, such as about 8 wt. % or less, such as about 6 wt. % or less, such as about 4 wt. % or less, such as about 2 wt. % or less, such as about 1.8 wt. % or less, such as about 1.5 wt. % or less, such as about 1.3 wt. % or less, such as about 1 wt. % or less, such as about 0.8 wt. % or less, such as about 0.5 wt. % or less, such as about 0.2 wt. % or less. If present, the reaction product may include phenol in an amount of greater than 0 wt. %, such as about 0.1 wt. % or more, such as about 0.2 wt. % or more, such as about 0.3 wt. % or more, such as about 0.4 wt. % or more, such as about 0.5 wt. % or more, such as about 0.6 wt. % or more, such as about 1 wt. % or more, such as about 1.5 wt. % or more. Also, the reaction product may include phenol with substituted phenols combined in an amount of about 15 wt. % or less, such as about 10 wt. % or less, such as about 8 wt. % or less, such as about 6 wt. % or less, such as about 4 wt. % or less, such as about 2 wt. % or less, such as about 1.8 wt. % or less, such as about 1.5 wt. % or less, such as about 1.3 wt. % or less, such as about 1 wt. % or less, such as about 0.8 wt. % or less, such as about 0.5 wt. % or less, such as about 0.2 wt. % or less. If present, the reaction product may include phenol with substituted phenols combined in an amount of greater than 0 wt. %, such as about 0.1 wt. % or more, such as about 0.2 wt. % or more, such as about 0.3 wt. % or more, such as about 0.4 wt. % or more, such as about 0.5 wt. % or more, such as about 0.6 wt. % or more, such as about 1 wt. % or more, such as about 1.5 wt. % or more.

As indicated above, the method as disclosed herein provides a reaction product comprising a phosphite ester. The reaction product may also comprise additional components, such as one or more compounds of structure (I). For instance, the reaction product may comprise a first compound of structure (I) and a second compound of structure (I) wherein both are different. In this regard, the reaction product may comprise phosphohalodite(s). In addition, the reaction product may also comprise a phosphite ester hydrolysis product. Thus, structure (I) may be utilized to depict a phosphohalodite and/or a phosphite ester hydrolysis product. In this regard, the reaction product may include a phosphohalodite of structure (I) wherein Y is -X, a phosphite ester hydrolysis product of structure (I) wherein Y is —OH, or a mixture thereof. In one embodiment, the reaction product may include a phosphohalodite of structure (I) wherein Y is -X. In one embodiment, the reaction product may include a phosphite ester hydrolysis product of structure (I) wherein Y is —OH. In another embodiment, the reaction product may include a phosphohalodite of structure (I) wherein Y is -X and a phosphite ester hydrolysis product of structure (I) wherein Y is —OH. In addition regarding the aforementioned, such reaction products may also include unreacted cresol.

Furthermore, the reaction product may have a certain halide content. In addition to the method herein, the present inventors have also discovered that controlling various parameters may also result in the synthesis of a reaction product having a predetermined halide content. For instance, such predetermined halide content may be a relatively high halide content or a relatively low halide content. In one embodiment, the reaction product may have a relatively high halide content such that the predetermined content is from about 10,000 ppm to about 15,000 ppm. In another embodiment, the reaction product may have a relatively low halide content such that the predetermined content is from about 3,000 ppm to about 5,000 ppm.

In addition, the method may also result in the synthesis of a reaction product having a predetermined phosphite ester and phosphohalodite content. For instance, the predetermined combined phosphite ester and phosphohalodite content may be greater than or equal to about 97 wt. %. Also, the method may result in the synthesis of a reaction product having a predetermined hydroxyl-substituted compound (e.g., cresol). For instance, the predetermined hydroxyl-substituted compound content may be less than or equal to about 1.5 wt. %. In addition, the method may result in the synthesis of a reaction product having a predetermined phosphite ester hydrolysis product. For instance, the predetermined phosphite ester hydrolysis product content may be less than or equal to about 1.5 wt. %. Also, in one embodiment, the reaction product may also have a predetermined phenol content of about 1.5 wt. % or less, such as about 1 wt. % or less, such as about 0.5 wt. % or less, such as about 0 wt. %. While the aforementioned provides 5 different specifications for predetermined amounts of various components, it should be understood that the method disclosed herein may provide a predetermined content of any combination of the aforementioned.

Various factors or parameters may contribute to providing a product have the aforementioned predetermined content. For instance, certain embodiments may include a control of various parameters, such as the stoichiometry of the hydroxyl-substituted compound to the phosphorus halide, the method of hydrogen halide removal, the initiation of hydrogen halide removal, the time (e.g., reaction hold time), and/or the temperature (e.g., reaction temperature). In one embodiment, at least the stoichiometry may play a more important role than some of the other parameters. Regardless, these parameters may be varied to provide a reaction product having a desired content of a particular component and/or meet a desired limit. In this regard, in some embodiments, the final product may advantageously contain predetermined levels of the phosphite ester (e.g., tristolylphosphite), phosphochlorodites, and halide (e.g., chloride) content.

For instance, and without intending to be limited, to produce a low halide content, in particular low chloride content, product, it may be desired to utilize a relatively lower stoichiometry/molar ratio of the hydroxyl substituted compound to the phosphorus halide, utilize sweep, utilize sparge, utilize vacuum, increase temperature, and/or increase reaction time. To produce a relatively high halide content, in particular high chloride content, product, it may be desired to utilize a relatively higher stoichiometry/molar ratio of the hydroxyl substituted compound to the phosphorus halide, utilize sweep, utilize sparge, decrease temperature, and/or decrease reaction time.

As indicated herein, the halide content (or total halides), in particular chloride content (or total chlorides), is determined and can be controlled. In general, these halides or chlorides may be derived from any residual hydrogen halide present in the reaction product. In addition, this may also include the halides or chlorides derived from any phosphohalodites (e.g., phosphochlorodites). Generally, a higher concentration of the phosphohalodites will result in a high halide content. The halide content, in particular chloride content, can be determined using means generally known in the art. For instance, it may be measured by titration.

The phosphite ester as disclosed herein may be utilized for various applications as generally known in the art. For instance, in one embodiment, a tristolyl phosphite ester may be utilized in the synthesis of a catalyst used to form adiponitrile which is a key precursor for hexamethylenediamine. The hexamethylenediamine can then be polymerized with an acid, such as adipic acid, for the formation of a polyamide, such as polyamide-6,6. Other uses of the phosphite ester as disclosed herein may include additives for electrolytes (e.g., for batteries such as lithium-ion batteries), stabilizers, plasticizers (e.g., for plastics or vinyls), wood preservatives, hydraulic fluid additives, etc.

### Example 1

The reaction was conducted using clean and dried glassware. Initially, 418.44 g of meta-cresol and para-cresol (3.869 mols) were charged to the reaction vessel (1 L) at a temperature of approximately 50-60° C. Once the temperature reached 80-85° C., the phosphorus trichloride was charged to the reaction vessel at a rate of about 1-1.5 m L/m in. The total amount of phosphorus trichloride was 186.50 g (1.358 mols). The molar ratio of the cresols to the phosphorus trichloride was approximately 2.85. Once the introduction of the cresols and phosphorus trichloride was completed, the reaction vessel was heated to the reaction temperature and held for a hold time as indicated in Table 1 below. In addition, any hydrogen chloride generated was removed using nitrogen sparge, nitrogen sweep combined with nitrogen sparge, or nitrogen sparge combined with vacuum, or vacuum as indicated in Table 1 below. Once completed, the vessel was cooled to less than 100° C. The reaction resulted in 464 g of tristolylphosphite and a yield of greater than 99%. In addition, the product included a generally high chloride content. For instance, the final product included approximately 10.17 wt. % of phosphochlorodites, 87.73 wt. % of tristolylphosphite, approx. 1 wt. % of cresol, approx. and 1 wt. % of phosphite ester hydrolysis product. The resulting product did not need to be purified. It was stored under inert atmosphere at ≤90° C.

The overview of each of seven processes as well as the method of hydrogen chloride removal is summarized in Table 1 below.

TABLE 1
Reaction conditions for production of phosphite ester,
phosphohalodite, and phosphite ester hydrolysis product.

| | | | | | | N₂ | |
|---|---|---|---|---|---|---|---|
| | | | | | | Sparge | |
| | | | N₂ | | | (1.3 L/ | |
| | | | Sweep | Atm | Reduced | min) | |
| | Reaction | Hold | (90 | Pressure | Pressure | & | Cycle |
| | Temp | Time | mL/ | (760 | (350 | Time | Time |
| | (° C.) | (h) | min) | mmHg) | mmHg) | (min) | (h) |
| Process | 150 | 1.5 | ✓ | ✓ | x | ✓ (10) | 4.8 |
| 1 | | | | | | | |
| Process | 150 | 2 | x | ✓ | x | ✓ (30) | 5.7 |
| 2 | | | | | | | |
| Process | 150 | 3 | x | x | ✓ (2.5 h) | ✓ (10) | 6.3 |
| 3 | | | | | | | |
| Process | 150 | 7.5 | x | x | ✓ (7 h) | × | 10.6 |
| 4 | | | | | | | |
| Process | 110 | 3.5 | ✓ | ✓ | x | ✓ (15) | 6.8 |
| 5 | | | | | | | |
| Process | 90 | 3.5 | ✓ | ✓ | x | ✓ (40) | 7.0 |
| 6 | | | | | | | |
| Process | 50 | 4 | ✓ | ✓ | x | ✓ (270) | 11.3 |
| 7 | | | | | | | |

In general, N₂ sweep is a constant nitrogen flow above the reaction mass surface. It can be provided using means known in the art. In the present example, a fritted gas dispersion tube was placed above the reaction mass for providing the nitrogen.

In general, N₂ sparge is a constant nitrogen flow below the reaction mass surface (i.e., sub-surface). It can be provided using means known in the art. In the present example, a fritted gas dispersion tube was placed below the reaction mass for providing the nitrogen.

As summarized in Table 1 above, efficient N₂ sparging (e.g., fine droplets and an even distribution from proximate the bottom of the reaction vessel with agitation) is advantageous to timely make an in-spec product. The assisted removal of HCl with an N₂ sparge, N₂ sweep, or vacuum reduces the time to make an in-spec product. In addition, a longer heating at about 150° C. terminal may not be beneficial compared to increased sparge time. Furthermore, below 150° C., longer heating and longer sparging time is needed.

### Process 1

The general reaction steps are provided in Tables 2a and 2b below for Process 1.

TABLE 2a
General process steps for production of phosphite ester,
phosphohalodite, and phosphite ester hydrolysis product under Process 1.

| Process 1 | |
|---|---|
| At 150° C. & Atmospheric Pressure with N₂ sweep (above-surface) + N₂ | Approx. |
| sparge | Time (mins) |
| Charge 418.44 g meta-para cresols in reactor at 50-60° C. | 10 |
| Sub-surface charge of 186.50 g PCl₃ at 1-1.5 mL/min in a reactor at | 80 |
| 80-85° C. | |
| Take to terminal condition (150° C. at 20° C./10 min; atm pressure; N₂ | 30 |
| sweep) | |
| Hold the reaction mass at 150° C. with N₂ sweep at atm pressure | 90 |
| Sub-surface sparge of N₂ at 1.3 L/min at 150° C. | 10 |
| Cool the batch to <100° C. and wait for an analysis | 60 |
| Discharge the product from the glass reactor (Once the batch in spec | 10 |
| Total | 290 |

TABLE 2b
Detailed process steps for production of phosphite ester,
phosphohalodite, and phosphite ester hydrolysis product under Process 1.

| No. | Process 1 Step |
|---|---|
| 1 | Before the addition of any reagent, pull vacuum on the system. Then, purge with |
| | N₂ to atm pressure. Repeat this process 3 times and then hold the system under |
| | a N₂ sweep. |
| 2 | Heat the 4 neck 1 L reactor to 50-60° C. |
| 3 | Charge 418.44 g (3.869 mols) dry meta & para cresols to the reactor at 50-60° C. |
| | Flush the reactor with N₂ sweep (~90 mL/min) using an N₂ sparge tube kept |
| | above the reaction mass surface. Instead of having a bubbler between N₂ and the |
| | reaction vessel, a water acid scrubber was used as the bubble to prevent HCl gas |
| | from back pressuring into the bubbler or remaining entrapped in the N₂ tubing. |
| 4 | Start stirring at 210 rpm using a medium sized magnetic stirrer bar. |
| 5 | Heat the 4 neck 1 L reactor to 80-85° C. |
| 6 | Slowly add phosphorus trichloride (PCl₃) sub-surface to the cresols at about 1-1.5 |
| | mL/min to the reactor using either a long stemmed oven-dried addition funnel or a |
| | peristatic pump with Teflon tubing. HCl bubbles can be seen coming out of the |
| | water scrubber at faster rate. The total amount of phosphorus trichloride was |
| | 186.50 g (1.358 mols; 118.49 mL). |
| 7 | Once the addition of PCl₃ is completed, begin to heat to 150° C. at 20° C./10 min. N₂ |
| | sweep is maintained. |
| 8 | Once at 150° C., hold the reaction mass for the hold time with N₂ sweep. |
| 9 | At the completion of the hold, move the above-surface sparge tube from central |
| | port of the 4 neck glass reactor to sub-surface and sparge nitrogen using a |
| | medium fritted gas dispersion tube for 10 min at a rate of 1.3 L/min. Once the 10 |
| | min is up, lift the sparge tube from sub-surface to above-surface of reaction mass |
| | and under gentle nitrogen flow take a 2-3 mL sample for analysis in an oven-dried |
| | sample vial using a glass pipette. |
| 10 | Cool to <100° C. while waiting for an analysis report. If chloride or cresol is out of |
| | spec, then continue with the reaction as needed by adding cresol or PCl₃ or by |
| | additional sparging. Then, reheat at 150° C. until the product comes within the limit |
| | after sampling. |
| 11 | Once within limit, cool the reactor to <100° C. under gentle N₂ pressure/sweep |
| | (~90 mL/min) and transfer the product to an oven dried N₂ flushed glass bottle. |

### Process 2

The general reaction steps are provided in Tables 3a and 3b below for Process 2.

TABLE 3a
General process steps for production of phosphite ester,
phosphohalodite, and phosphite ester hydrolysis product under Process 2.

| Process 2 | Approx. |
|---|---|
| Without N₂ sweep (above-surface) or vacuum + N₂ sparge | Time (mins) |
| Charge 418.44 g meta-para cresols in reactor at 50-60° C. | 10 |
| Sub-surface charge of 186.50 g PCl₃ at 1-1.5 mL/min in a reactor at | 80 |
| 80-85° C. | |
| Take to terminal condition (150° C. at 20° C./10 min; atm pressure; | 30 |
| without N₂ sweep) | |
| Hold the reaction mass at 150° C. without N₂ sweep at atm pressure | 120 |
| Sub-surface sparge of N₂ at 1.3 L/min at 150° C. | 30 |
| Cool the batch to <100° C. and wait for an analysis | 60 |
| Discharge the product from the glass reactor (Once the batch in spec | 10 |
| Total | 340 |

TABLE 3b
Detailed process steps for production of phosphite ester,
phosphohalodite, and phosphite ester hydrolysis product under Process 2.

| No. | Process 2 Step |
|---|---|
| 1 | Before the addition of any reagent, pull vacuum on the system. Then, purge with |
| | N₂ to atm pressure. Repeat this process 3 times and then hold the system under |
| | a N₂ sweep. |
| 2 | Heat the 4 neck 1 L reactor to 50-60° C. |
| 3 | Charge 418.44 g (3.869 mols) dry meta & para cresols to the reactor at 50-60° C. |
| | Flush the reactor with N₂ sweep (~90 mL/min) using an N₂ sparge tube kept |
| | above the reaction mass surface and then stop N₂ flow. Instead of having a |
| | bubbler between N₂ and the reaction vessel, a water acid scrubber was used as |
| | the bubble to prevent HCl gas from back pressuring into the bubbler or remaining |
| | entrapped in the N₂ tubing. |
| 4 | Start stirring at 210 rpm using a medium sized magnetic stirrer bar. |
| 5 | Heat the 4 neck 1 L reactor to 80-85° C. |
| 6 | Slowly add phosphorus trichloride (PCl₃) sub-surface to the cresols at about 1-1.5 |
| | mL/min to the reactor using either a long stemmed oven-dried addition funnel or a |
| | peristatic pump with Teflon tubing. HCl bubbles can be seen coming out of the |
| | water scrubber at faster rate. The total amount of phosphorus trichloride was |
| | 186.50 g (1.358 mols; 118.49 mL). |
| 7 | Once the addition of PCl₃ is completed, begin to heat to 150° C. at 20° C./10 min. No |
| | N₂ sweep. |
| 8 | Once at 150° C., hold the reaction mass for the hold time without N₂ sweep. |
| 9 | At the completion of the hold, move the above-surface sparge tube from central |
| | port of the 4 neck glass reactor to sub-surface and sparge nitrogen using a |
| | medium fritted gas dispersion tube for 30 min at a rate of 1.3 L/min. Once the 30 |
| | min is up, lift the sparge tube from sub-surface to above-surface of reaction mass |
| | and under gentle nitrogen flow take a 2-3 mL sample for analysis in an oven-dried |
| | sample vial using a glass pipette. |
| 10 | Cool to <100° C. while waiting for an analysis report. If chloride or cresol is out of |
| | spec, then continue with the reaction as needed by adding cresol or PCl₃ or by |
| | additional sparging. Then, reheat at 150° C. until the product comes within the limit |
| | after sampling. |
| 11 | Once within limit, cool the reactor to <100° C. under gentle N₂ pressure/sweep |
| | (~90 mL/min) and transfer the product to an oven dried N₂ flushed glass bottle. |

### Process 3

The general reaction steps are provided in Tables 4a and 4b below for Process 3:

TABLE 4a
General process steps for production of phosphite ester,
phosphohalodite, and phosphite ester hydrolysis product under Process 3.

| Process 3 | Approx. |
|---|---|
| At 150° C. under reduced pressure 350 mmHg (without sweep) + N₂ sparge | Time (mins) |
| Charge 418.44 g meta-para cresols in reactor at 50-60° C. | 10 |
| Sub-surface charge of 186.50 g PCl₃ at 1-1.5 mL/min in a reactor at | 80 |
| 80-85° C. | |
| Take to terminal condition (150° C. at 20° C./10 min; atm pressure; without | 30 |
| N₂ sweep) | |
| Hold the reaction mass at 150° C. & 450 mmHg | 30 |
| Reduce to 350 mmHg and hold the reaction mass at 150° C./350 mmHg. | 150 |
| Sub-surface sparge of N₂ at 1.3 L/min at 150° C. | 10 |
| Cool the batch to <100° C. and wait for an analysis | 60 |
| Discharge the product from the glass reactor (Once the batch is in spec) | 10 |
| Total | 380 |

TABLE 4b
Detailed process steps for production of phosphite ester,
phosphohalodite, and phosphite ester hydrolysis product under Process 3.

| No. | Process 3 Step |
|---|---|
| 1 | Before the addition of any reagent, pull vacuum on the system. Then, purge with |
| | N₂ to atm pressure. Repeat this process 3 times and then hold the system under |
| | a N₂ sweep. |
| 2 | Heat the 4 neck 1 L reactor to 50-60° C. |
| 3 | Charge 418.44 g (3.869 mols) dry meta & para cresols to the reactor at 50-60° C. |
| | Flush the reactor with N₂ sweep (~90 mL/min) using an N₂ sparge tube kept |
| | above the reaction mass surface and then stop. Instead of having a bubbler |
| | between N₂ and the reaction vessel, a water acid scrubber was used as the |
| | bubble to prevent HCl gas from back pressuring into the bubbler or remaining |
| | entrapped in the N₂ tubing. |
| 4 | Start stirring at 210 rpm using a medium sized magnetic stirrer bar. |
| 5 | Heat the 4 neck 1 L reactor to 80-85° C. |
| 6 | Slowly add phosphorus trichloride (PCl₃) sub-surface to the cresols at about 1-1.5 |
| | mL/min to the reactor using either a long stemmed oven-dried addition funnel or a |
| | peristatic pump with Teflon tubing at atmospheric pressure. HCl bubbles can be |
| | seen coming out of the water scrubber at faster rate. No N₂ sweep is done |
| | above-surface during this time. The total amount of phosphorus trichloride was |
| | 186.50 g (1.358 mols; 118.49 mL). |
| 7 | Once the addition of PCl₃ is completed, begin to heat to 150° C. at 20° C./10 min. No |
| | N₂ sweep. |
| 8 | Once at 150° C., the water scrubber is taken off from an outlet of condenser. |
| | Condenser outlet is connected to water aspirator and an atmospheric pressure |
| | (760 mmHg) is slowly reduced to 450 mmHg directly. |
| 9 | The reactor kettle is held for 0.5 h (30 minutes) at 150° C. and 450 mmHg using |
| | water respirator directly connected to condenser. |
| 10 | Subsequently, the pressure was further reduced to 350 mmHg, and the reactor |
| | kettle is held for 3 h (180 min) at 150° C./350 mmHg using water respirator directly |
| | connected to condenser. |
| 11 | At the completion of the hold, slowly disconnect the water respirator and bring the |
| | reaction mass to atmospheric pressure. Move the sparge tube from central port of |
| | the 4 neck glass reactor to sub-surface and sparge nitrogen using a medium |
| | fritted gas dispersion tube for 10 min at a rate of 1.3 L/min. Once the 10 min is up, |
| | lift the sparge tube from subsurface to above-surface of reaction mass and under |
| | gentle nitrogen flow take a 2-3 mL sample for analysis in an oven-dried sample |
| | vial using a glass pipette. |
| 12 | Cool to <100° C. while waiting for an analysis report. If chloride or cresol is out of |
| | spec, then continue with the reaction as needed by adding cresol or PCl₃ or by |
| | additional sparging. Then, reheat at 150° C. until the product comes within the limit |
| | after sampling. |
| 13 | Once within limit, cool the reactor to <100° C. under gentle N₂ pressure/sweep |
| | (~90 mL/min) and transfer the product to an oven dried N₂ flushed glass bottle. |

### Process 4

The general reaction steps are provided in Tables 5a and 5b below for Process 4.

TABLE 5a
General process steps for production of phosphite ester,
phosphohalodite, and phosphite ester hydrolysis product under Process 4.

| Process 4 | Approx. |
|---|---|
| At 150° C. under reduced pressure 350 mmHg only (without N₂ sweep or N₂ | Time |
| Sparge) | (mins) |
| Charge 418.44 g meta-para cresols in reactor at 50-60° C. | 10 |
| Sub-surface charge of 186.50 g PCl₃ at 1-1.5 mL/min in a reactor at | 80 |
| 80-85° C. | |
| Take to terminal condition (150° C. at 20° C./10 min; atm pressure; without | 30 |
| N₂ sweep) | |
| Hold the reaction mass at 150° C. & 450 mmHg | 30 |
| Reduce to 350 mmHg and hold the reaction mass at 150° C./350 mmHg. | 420 |
| Cool the batch to <100° C. and wait for an analysis | 60 |
| Discharge the product from the glass reactor (Once the batch is in spec) | 10 |
| Total | 640 |

TABLE 5b
Detailed process steps for production of phosphite ester,
phosphohalodite, and phosphite ester hydrolysis product under Process 4.

| No. | Process 4 Step |
|---|---|
| 1 | Before the addition of any reagent, pull vacuum on the system. Then, purge with |
| | N₂ to atm pressure. Repeat this process 3 times and then hold the system under |
| | a N₂ sweep. |
| 2 | Heat the 4 neck 1 L reactor to 50-60° C. |
| 3 | Charge 418.44 g (3.869 mols) dry meta & para cresols to the reactor at 50-60° C. |
| | Flush the reactor with N₂ sweep (~90 mL/min) using an N₂ sparge tube kept |
| | above the reaction mass surface and then stop. Instead of having a bubbler |
| | between N₂ and the reaction vessel, a water acid scrubber was used as the |
| | bubble to prevent HCl gas from back pressuring into the bubbler or remaining |
| | entrapped in the N₂ tubing. |
| 4 | Start stirring at 210 rpm using a medium sized magnetic stirrer bar. |
| 5 | Heat the 4 neck 1 L reactor to 80-85° C. |
| 6 | Slowly add phosphorus trichloride (PCl₃) sub-surface to the cresols at about 1-1.5 |
| | mL/min to the reactor using either a long stemmed oven-dried addition funnel or a |
| | peristatic pump with Teflon tubing at atmospheric pressure. HCl bubbles can be |
| | seen coming out of the water scrubber at faster rate. No N₂ sweep is done |
| | above-surface during this time. The total amount of phosphorus trichloride was |
| | 186.50 g (1.358 mols; 118.49 mL). |
| 7 | Once the addition of PCl₃ is completed, begin to heat to 150° C. at 20° C./10 min. No |
| | N₂ sweep. |
| 8 | Once at 150° C., the water scrubber is taken off from an outlet of condenser. |
| | Condenser outlet is connected to water aspirator and an atmospheric pressure |
| | (760 mmHg) is slowly reduced to 450 mmHg directly. |
| 9 | The reactor kettle is held for 0.5 h (30 minutes) at 150° C. and 450 mmHg using |
| | water respirator directly connected to condenser. |
| 10 | Subsequently, the pressure was further reduced to 350 mmHg, and the reactor |
| | kettle is held for 7 h (420 min) at 150° C./350 mmHg using water respirator directly |
| | connected to condenser. |
| 11 | At the completion of the hold, slowly disconnect the water respirator and bring the |
| | reaction mass to atmospheric pressure. Move the sparge tube from central port of |
| | the 4 neck glass reactor to sub-surface and sparge nitrogen using a medium |
| | fritted gas dispersion tube for 10 min at a rate of 1.3 L/min. Once the 10 min is up, |
| | lift the sparge tube from subsurface to above-surface of reaction mass and under |
| | gentle nitrogen flow take a 2-3 mL sample for analysis in an oven-dried sample |
| | vial using a glass pipette. |
| 12 | Cool to <100° C. while waiting for an analysis report. If chloride or cresol is out of |
| | spec, then continue with the reaction as needed by adding cresol or PCl₃ or by |
| | additional sparging. Then, reheat at 150° C. until the product comes within the limit |
| | after sampling. |
| 13 | Once within limit, cool the reactor to <100° C. under gentle N₂ pressure/sweep |
| | (~90 mL/min) and transfer the product to an oven dried N₂ flushed glass bottle. |

### Process 5

The general reaction steps are provided in Tables 6a and 6b below for Process 5.

TABLE 6a
General process steps for production of phosphite ester,
phosphohalodite, and phosphite ester hydrolysis product under Process 5.

| Process 5 | |
|---|---|
| At 110° C. & Atmospheric Pressure with N₂ sweep (above-surface) + N₂ | Approx. |
| sparge | Time (mins) |
| Charge 418.44 g meta-para cresols in reactor at 50-60° C. | 10 |
| Sub-surface charge of 186.50 g PCl₃ at 1-1.5 mL/min in a reactor at | 80 |
| 80-85° C. | |
| Take to terminal condition (110° C. at 10° C./10 min; atm pressure; N₂ | 25 |
| sweep) | |
| Hold the reaction mass at 110° C. with N₂ sweep at atm pressure | 210 |
| Sub-surface sparge of N₂ at 1.3 L/min at 110° C. | 15 |
| Cool the batch to <100° C. and wait for an analysis | 60 |
| Discharge the product from the glass reactor (Once the batch is in spec) | 10 |
| Total | 410 |

TABLE 6b
Detailed process steps for production of phosphite ester,
phosphohalodite, and phosphite ester hydrolysis product under Process 5.

| No. | Process 5 Step |
|---|---|
| 1 | Before the addition of any reagent, pull vacuum on the system. Then, purge with |
| | N₂ to atm pressure. Repeat this process 3 times and then hold the system under |
| | a N₂ sweep. |
| 2 | Heat the 4 neck 1 L reactor to 50-60° C. |
| 3 | Charge 418.44 g (3.869 mols) dry meta & para cresols to the reactor at 50-60° C. |
| | Flush the reactor with N₂ sweep (~90 mL/min) using an N₂ sparge tube kept |
| | above the reaction mass surface. Instead of having a bubbler between N₂ and the |
| | reaction vessel, a water acid scrubber was used as the bubble to prevent HCl gas |
| | from back pressuring into the bubbler or remaining entrapped in the N₂ tubing. |
| 4 | Start stirring at 210 rpm using a medium sized magnetic stirrer bar. |
| 5 | Heat the 4 neck 1 L reactor to 80-85° C. |
| 6 | Slowly add phosphorus trichloride (PCl₃) sub-surface to the cresols at about 1-1.5 |
| | mL/min to the reactor using either a long stemmed oven-dried addition funnel or a |
| | peristatic pump with Teflon tubing. HCl bubbles can be seen coming out of the |
| | water scrubber at faster rate. The total amount of phosphorus trichloride was |
| | 186.50 g (1.358 mols; 118.49 mL). |
| 7 | Once the addition of PCl₃ is completed, begin to heat to 110° C. at 20° C./10 min. N₂ |
| | sweep is maintained. |
| 8 | Once at 110° C., hold the reaction mass for the hold time while N₂ sweep is |
| | continued. |
| 9 | At the completion of the hold, move the above-surface sparge tube from central |
| | port of the 4 neck glass reactor to sub-surface and sparge nitrogen using a |
| | medium fritted gas dispersion tube for 15 min at a rate of 1.3 L/min. Once the 15 |
| | min is up, lift the sparge tube from sub-surface to above-surface of reaction mass |
| | and under gentle nitrogen flow take a 2-3 mL sample for analysis in an oven-dried |
| | sample vial using a glass pipette. |
| 10 | Cool to <100° C. while waiting for an analysis report. If chloride or cresol is out of |
| | spec, then continue with the reaction as needed by adding cresol or PCl₃ or by |
| | additional sparging. Then, reheat at 110° C. until the product comes within the limit |
| | after sampling. |
| 11 | Once within limit, cool the reactor to <100° C. under gentle N₂ pressure/sweep |
| | (~90 mL/min) and transfer the product to an oven dried N₂ flushed glass bottle. |

### Process 6

The general reaction steps are provided in Tables 7a and 7b below for Process 6.

TABLE 7a
General process steps for production of phosphite ester,
phosphohalodite, and phosphite ester hydrolysis product under Process 6.

| Process 6 | |
|---|---|
| At 90° C. & Atmospheric Pressure with N₂ sweep (above-surface) + N₂ | Approx. |
| sparge | Time (mins) |
| Charge 418.44 g meta-para cresols in reactor at 50-60° C. | 10 |
| Sub-surface charge of 186.50 g PCl₃ at 1-1.5 mL/min in a reactor at | 80 |
| 80-85° C. | |
| Take to terminal condition (90° C. at 10° C./10 min; atm pressure; N₂ sweep) | 10 |
| Hold the reaction mass at 90° C. with N₂ sweep at atm pressure | 210 |
| Sub-surface sparge of N₂ at 1.3 L/min at 90° C. | 40 |
| Cool the batch to <100° C. and wait for an analysis | 60 |
| Discharge the product from the glass reactor (Once the batch is in spec) | 10 |
| Total | 420 |

TABLE 7b
Detailed process steps for production of phosphite ester,
phosphohalodite, and phosphite ester hydrolysis product under Process 6.

| No. | Process 6 Step |
|---|---|
| 1 | Before the addition of any reagent, pull vacuum on the system. Then, purge with |
| | N₂ to atm pressure. Repeat this process 3 times and then hold the system under |
| | a N₂ sweep. |
| 2 | Heat the 4 neck 1 L reactor to 50-60° C. |
| 3 | Charge 418.44 g (3.869 mols) dry meta & para cresols to the reactor at 50-60° C. |
| | Flush the reactor with N₂ sweep (~90 mL/min) using an N₂ sparge tube kept |
| | above the reaction mass surface. Instead of having a bubbler between N₂ and the |
| | reaction vessel, a water acid scrubber was used as the bubble to prevent HCl gas |
| | from back pressuring into the bubbler or remaining entrapped in the N₂ tubing. |
| 4 | Start stirring at 210 rpm using a medium sized magnetic stirrer bar. |
| 5 | Heat the 4 neck 1 L reactor to 80-85° C. |
| 6 | Slowly add phosphorus trichloride (PCl₃) sub-surface to the cresols at about 1-1.5 |
| | mL/min to the reactor using either a long stemmed oven-dried addition funnel or a |
| | peristatic pump with Teflon tubing. HCl bubbles can be seen coming out of the |
| | water scrubber at faster rate. The total amount of phosphorus trichloride was |
| | 186.50 g (1.358 mols; 118.49 mL). |
| 7 | Once the addition of PCl₃ is completed, begin to heat to 90° C. at 10° C./10 min. N₂ |
| | sweep is maintained. |
| 8 | Once at 90° C., hold the reaction mass for the hold time while N₂ sweep is |
| | continued. |
| 9 | At the completion of the hold, move the above-surface sparge tube from central |
| | port of the 4 neck glass reactor to sub-surface and sparge nitrogen using a |
| | medium fritted gas dispersion tube for 40 min at a rate of 1.3 L/min. Once the 40 |
| | min is up, lift the sparge tube from sub-surface to above-surface of reaction mass |
| | and under gentle nitrogen flow take a 2-3 mL sample for analysis in an oven-dried |
| | sample vial using a glass pipette. |
| 10 | Cool to <100° C. while waiting for an analysis report. If chloride or cresol is out of |
| | spec, then continue with the reaction as needed by adding cresol or PCl₃ or by |
| | additional sparging. Then, reheat at 90° C. until the product comes within the limit |
| | after sampling. |
| 11 | Once within limit, cool the reactor to <100° C. under gentle N₂ pressure/sweep |
| | (~90 mL/min) and transfer the product to an oven dried N₂ flushed glass bottle. |

### Process 7

The general reaction steps are provided in Tables 8a and 8b below for Process 7.

TABLE 8a
General process steps for production of phosphite ester,
phosphohalodite, and phosphite ester hydrolysis product under Process 7.

| Process 7 | |
|---|---|
| At 50° C. & Atmospheric Pressure with N₂ sweep (above-surface) + N₂ | Approx. |
| sparge | Time (mins) |
| Charge 418.44 g meta-para cresols in reactor at 50-60° C. | 10 |
| Sub-surface charge of 186.50 g PCl₃ at 1-1.5 mL/min in a reactor at 80- | 80 |
| 85° C. | |
| Take to terminal condition (50° C. at 10° C./10 min; atm pressure; N₂ sweep) | 5 |
| Hold the reaction mass at 50° C. with N₂ sweep at atm pressure | 240 |
| Sub-surface sparge of N₂ at 1.3 L/min at 50° C. | 270 |
| Cool the batch to <100° C. and wait for an analysis | 60 |
| Discharge the product from the glass reactor (Once the batch is in spec) | 10 |
| Total | 675 |

TABLE 8b
Detailed process steps for production of phosphite ester,
phosphohalodite, and phosphite ester hydrolysis product under Process 7.

| No. | Process 7 Step |
|---|---|
| 1 | Before the addition of any reagent, pull vacuum on the system. Then, purge with |
| | N₂ to atm pressure. Repeat this process 3 times and then hold the system under |
| | a N₂ sweep. |
| 2 | Heat the 4 neck 1 L reactor to 50-60° C. |
| 3 | Charge 418.44 g (3.869 mols) dry meta & para cresols to the reactor at 50-60° C. |
| | Flush the reactor with N₂ sweep (~90 mL/min) using an N₂ sparge tube kept |
| | above the reaction mass surface. Instead of having a bubbler between N₂ and the |
| | reaction vessel, a water acid scrubber was used as the bubble to prevent HCl gas |
| | from back pressuring into the bubbler or remaining entrapped in the N₂ tubing. |
| 4 | Start stirring at 210 rpm using a medium sized magnetic stirrer bar. |
| 5 | Heat the 4 neck 1 L reactor to 80-85° C. |
| 6 | Slowly add phosphorus trichloride (PCl₃) sub-surface to the cresols at about 1-1.5 |
| | mL/min to the reactor using either a long stemmed oven-dried addition funnel or a |
| | peristatic pump with Teflon tubing. HCl bubbles can be seen coming out of the |
| | water scrubber at faster rate. The total amount of phosphorus trichloride was |
| | 186.50 g (1.358 mols; 118.49 mL). |
| 7 | Once the addition of PCl₃ is completed, begin to heat to 50° C. at 20° C./10 min. N₂ |
| | sweep is maintained. |
| 8 | Once at 50° C., hold the reaction mass for the hold time while N₂ sweep is |
| | continued. |
| 9 | At the completion of the hold, move the above-surface sparge tube from central |
| | port of the 4 neck glass reactor to sub-surface and sparge nitrogen using a |
| | medium fritted gas dispersion tube for 30 min at a rate of 1.3 L/min. Once the 270 |
| | min is up, lift the sparge tube from sub-surface to above-surface of reaction mass |
| | and under gentle nitrogen flow take a 2-3 mL sample for analysis in an oven-dried |
| | sample vial using a glass pipette. |
| 10 | Cool to <100° C. while waiting for an analysis report. If chloride or cresol is out of |
| | spec, then continue with the reaction as needed by adding cresol or PCl₃ or by |
| | additional sparging. Then, reheat at 50° C. until the product comes within the limit |
| | after sampling. |
| 11 | Once within limit, cool the reactor to <100° C. under gentle N₂ pressure/sweep |
| | (~90 mL/min) and transfer the product to an oven dried N₂ flushed glass bottle. |

### Example 2

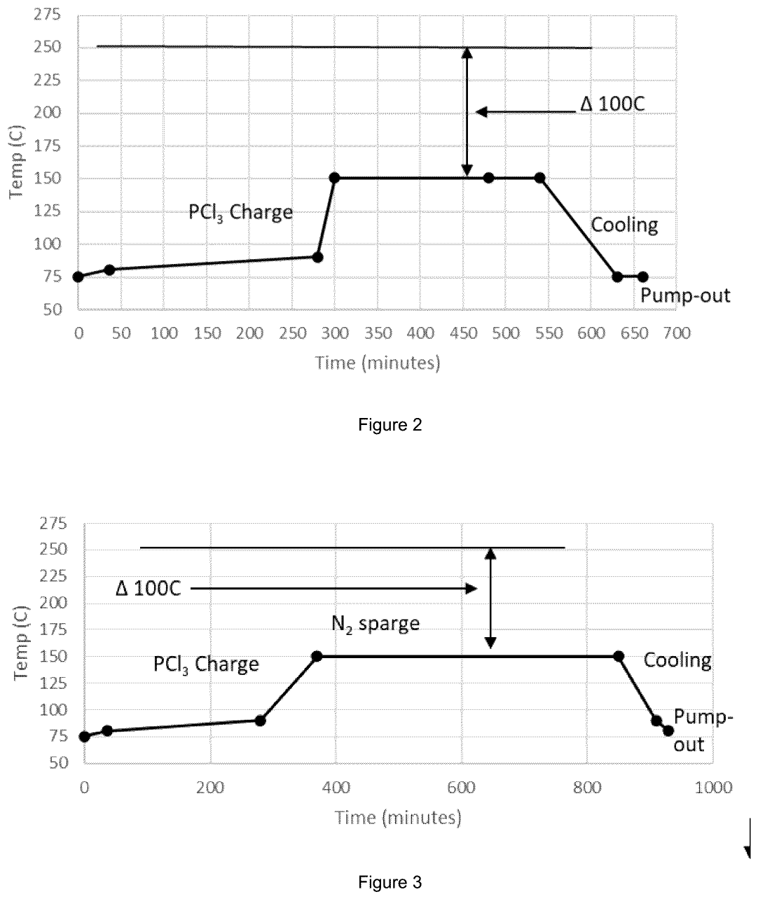

Temperature versus time figures are presented in FIGS. 2 and 3 and illustrate the process for the synthesis of a high chloride content and low chloride content, respectively, product in accordance with one embodiment of the present disclosure. For instance, in both figures, the m-cresol/p-cresol is initially charged to the reaction vessel. Thereafter, PCIS is charged to the vessel over an extended period of time. Once charged, the vessel is heated gradually to 150° C., and then an N₂ sparge is started through the reaction mass in the vessel where it is held for a specified duration of time until a limit is satisfied. (However, as indicated above, in other embodiments, the HCl removal can begin prior to reaching the final reaction temperature—such as around 95° C. with a final reaction temperature of about 150° C.—immediately once the PCl₃ is charged.) Thereafter, the contents are cooled and the reaction product is pumped out. In alternative embodiments, following cresol and PCl₃ charging, N₂ sparging, N₂ sweeping, and/or vacuum are immediately begun prior to heating to the desired reaction temperature, for example 150° C., and are continued throughout heating at the reaction temperature and during the holding period at the reaction temperature. In some embodiments, N₂ sparging, N₂ sweeping, and/or vacuum are immediately begun prior to heating to the desired reaction temperature, for example 150° C., and continued throughout heating at the reaction temperature and during the holding period at the reaction temperature surprisingly and unexpectedly further reduces cycle times, even to less than those shown in FIGS. 2 and 3.

### Example 3

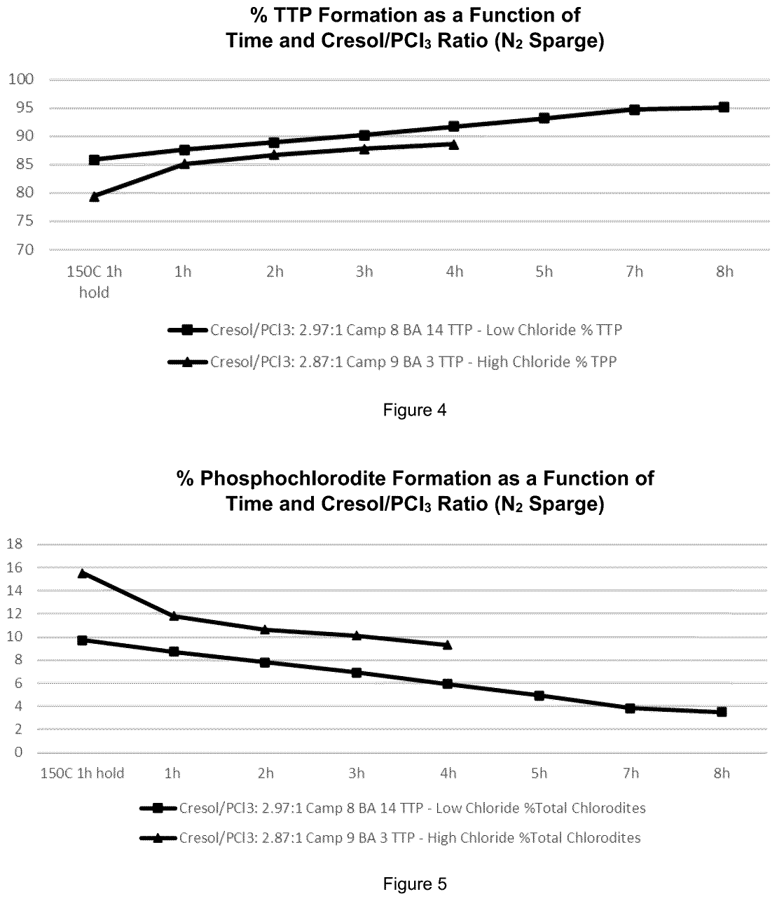

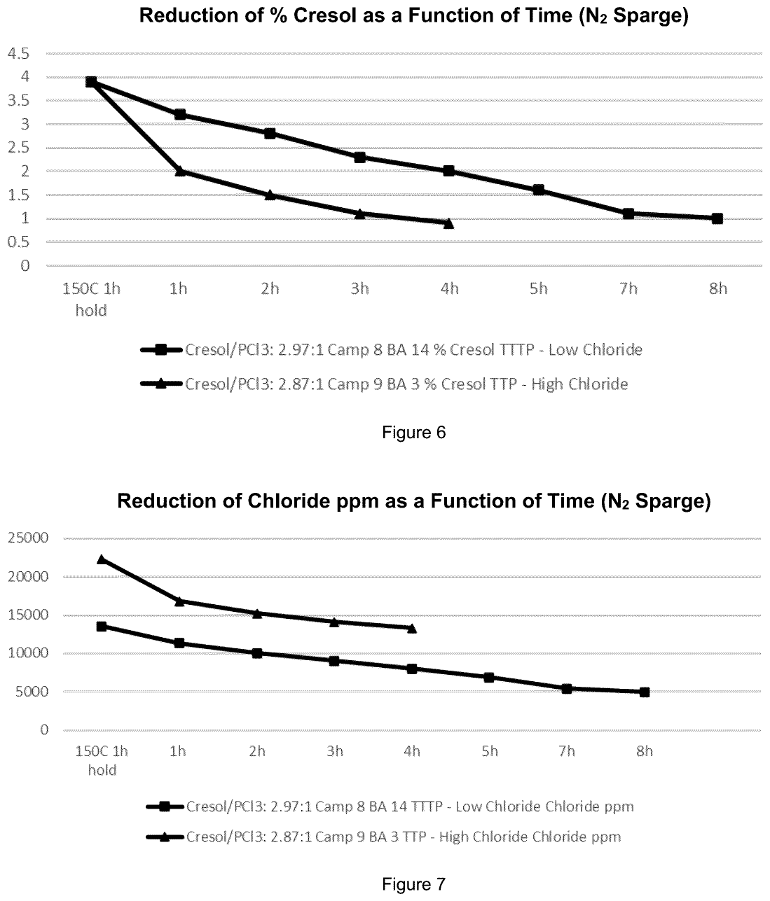

The effect of the molar ratio of cresol to phosphorus trichloride was observed as illustrated in FIGS. 4-7. In particular, the molar ratios were 2.97:1 and 2.87:1. In addition, nitrogen sparge was utilized and the reaction was conducted at 150° C. The effect on the % tristolylphosphite, % phosphochlorodites, % cresol, and chloride content for the final reaction product was determined as a function of time. As observed, the % TTP increased over time while the remaining components decreased over time.

### Example 4

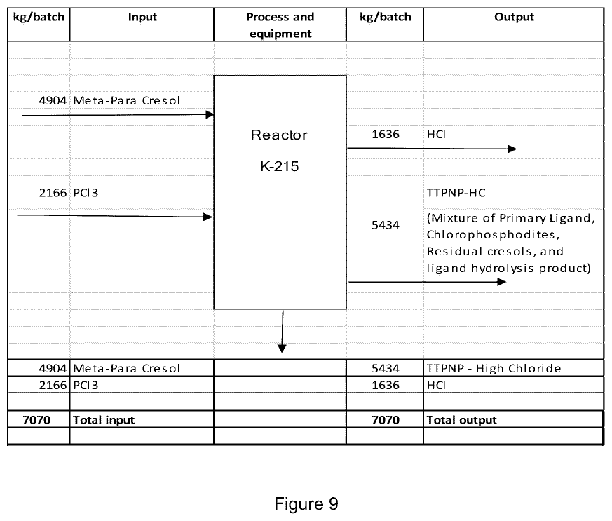

A process diagram with an example mass balance is illustrated in FIG. 9. In the diagram, meta-para cresol and PCIS are introduced to the reactor. The reaction yields HCl as well as TTP with phosphochlorodites, residual cresol, and any phosphite ester hydrolysis product.

### Example 5

The following example is directed to the synthesis of a low chlorides tristolyl phosphite ester product. Utilizing a 2275 gallon (304 ft 3) reactor, cresol (approx. 10811 lbs) was first charged followed by PCIS (approx. 4609 lbs). The reaction was heated to 150° C. and then nitrogen sparge at 10 cubic feet per minute was initiated (gas hourly space velocity of 1.97/hour). In this example, no sweeping or vacuum was utilized; instead only nitrogen sparge was utilized when the temperature reached 150° C. The total sparge time was 7-8 hours. The product resulted in less than 1.5% residual cresol with a chloride content of between 3,000-5,000 ppm.

TABLE 9
Reactant charge amounts and concentration sampling during reaction for Example 5.

| Cresol:PCl₃ molar ratio | 2.94 | | 2.95 | | 2.96 | | 2.97 | |
|---|---|---|---|---|---|---|---|---|
| PCl₃ charge | 4664 lb | | 4652 lb | | 4638 lb | | 4624 lb | |
| | Cresol | Chlorides | Cresol | Chlorides | Cresol | Chlorides | Cresol | Chlorides |
| Sample point | % | (ppm) | % | (ppm) | % | (ppm) | % | (ppm) |
| 150° C. 1 h | 4.4 | 15941 | 3.9 | 15526 | — | — | — | — |
| 1 h sparge | — | — | 3.2 | 12582 | 2.2 | 9910 | 2.7 | 11598 |
| 3 h sparge | 2.7 | 11162 | 2.2 | 9483 | 1.8 | 8521 | 1.9 | 8273 |
| 5 h sparge | 1.5 | 7676 | 1.5 | 7075 | 1.4 | 7717 | 1.4 | 6946 |
| 7 h sparge | 1.1 | 6498 | 1.2 | 5926 | 1.0 | 6692 | 1.2 | 6321 |
| 8 h sparge | — | — | 1.0 | 5189 | — | — | — | — |
| 9 h sparge | — | — | — | — | 0.8 | 5770 | 0.9 | 5337 |
| 9.5 h sparge | — | — | 0.9 | 4825 | — | — | — | — |
| 10 h sparge | — | — | — | — | — | — | 0.8 | 5017 |
| 11 h sparge | — | — | — | — | 0.6 | 5051 | 0.7 | 4651 |
| (Cooling/Lotting) | | | | | | | | |
| Cooling/Lotting | 0.9 | 6156 | 0.8 | 4571 | | | | |

| Cresol:PCl₃ molar ratio | 2.975 | | 2.977 | | 2.979 | |
|---|---|---|---|---|---|---|
| PCl₃ charge | 4616 lb | | 4612 lb | | 4609 lb | |
| | Cresol | Chlorides | Cresol | Chlorides | Cresol | Chlorides |
| Sample point | % | (ppm) | % | (ppm) | % | (ppm) |
| 150° C. 1 h | 4.2 | 15347 | 3.9 | 13516 | 4.7 | 13257 |
| 1 h sparge | — | — | 3.2 | 11332 | 3.8 | 11133 |
| 3 h sparge | 2.1 | 8500 | 2.4 | 9813 | 2.7 | 7103 |
| 5 h sparge | 1.4 | 6475 | 1.6 | 6835 | 2.1 | 5155 |
| 7 h sparge | 1.1 | 5321 | 1.1 | 5408 | 1.7 | 4440 |
| 8 h sparge | — | — | 1.0 | 4927 | 1.4 | 3508 |
| 9 h sparge | — | — | — | — | — | — |
| 9.5 h sparge | — | — | — | — | — | — |
| 10 h sparge | — | — | — | — | — | — |
| 11 h sparge | — | — | — | — | — | — |
| (Cooling/Lotting) | | | | | | |
| Cooling/Lotting | 1.0 | 4730 | 1.0 | 4642 | 1.4 | 3508 |

As the cresol to PCl₃ molar ratio increased, more residual cresol was observed in the final product and less chlorides were observed in the final product. According to this study, an optimal molar ratio of between 2.975 to 2.98 of cresol/PCl₃ was determined.

### Example 6

The following example is directed to the synthesis of a low chlorides tristolyl phosphite ester product. Utilizing a 2275 gallon (304 ft³) reactor, cresol (approx. 11182 lbs) was first charged followed by PCl₃ (approx. 4775 lbs). The reaction was heated to 150° C. In certain examples, nitrogen sparge at 10 cubic feet per minute was initiated (gas hourly space velocity of 1.97/hour). Similarly, in certain examples, nitrogen sweeping was utilized at 15 or 25 psi (25 psi-5-6 CFM, 1.1/hour gas hourly space velocity). In some examples, the sweeping and sparging were started earlier than reaching the 150° C. reaction temperature. For example, in some cases, it was started as soon as the PCl₃ addition was completed and/or when the temperature was 95° C. The product resulted in less than 1.5% residual cresol with a chloride content of between 3,000-5,000 ppm.

TABLE 10
Reactant charge amounts and concentration sampling during reaction for Example 6.

| Cresol:PCl₃ molar ratio | 2.975 | | 2.975 | | 2.975 | | 2.970 | |
|---|---|---|---|---|---|---|---|---|
| Charge | PCl₃ 4616 lb | | PCl₃ 4616 lb | | PCl₃ 4616 lb | | Cresol 10814 lb & | |
| | | | | | | | PCl₃ 4624 lb | |
| Conditions | No sweep | | N₂ sweep @ | | N₂ sweep @ | | 150° C. 1 h hold; | |
| | | | 10 psi | | 10 psi | | then N₂ sparging | |
| | | | | | | | at 10 cfm and N₂ | |
| | | | | | | | sweeping at 10 | |
| | | | | | | | psi for 5 h and | |
| | | | | | | | then N₂ sweeping | |
| | | | | | | | increased to 15 | |
| | | | | | | | psi | |
| | Cresol | Chlorides | Cresol | Chlorides | Cresol | Chlorides | Cresol | Chlorides |
| Sample point | % | (ppm) | % | (ppm) | % | (ppm) | % | (ppm) |
| At 100° C. | — | — | — | — | — | — | — | — |
| At 150° C. | — | — | — | — | — | — | — | — |
| 150° C. 1 h | 4.2 | 15347 | 4.1 | 13454 | 5.1 | 15885 | — | — |
| 1 h sparge | — | — | — | — | — | — | — | — |
| 2 h sparge | — | — | — | — | — | — | — | — |
| 3 h sparge | 2.1 | 8500 | 3.6 | 11569 | 2.2 | 8809 | — | — |
| 4 h sparge | — | — | — | — | — | — | — | — |
| 5 h sparge | 1.4 | 6475 | 2.3 | 7285 | 1.5 | 6865 | 10.8 | 6561 |
| 6 h sparge | — | — | — | — | — | — | — | — |
| 7 h sparge | 1.1 | 5321 | 1.2 | 3913 | 1.0 | 5414 | 1.4 | 4950 |
| 8 h sparge | — | — | — | — | — | — | 1.1 | 4739 |
| 9 h sparge | — | — | — | — | — | — | — | — |
| 9.5 h sparge | — | — | — | — | — | — | — | — |
| 10 h sparge | — | — | — | — | — | — | — | — |
| 11 h sparge | — | — | — | — | — | — | — | — |
| (Cooling/Lotting) | | | | | | | | |
| Cooling/Lotting | 1.0 | 4730 | 1.2 | 3832 | 0.8 | 4668 | 1.1 | 4739 |
| Total Cycle | | | | | | | | |
| Time | | | | | | | | |
| Cresol:PCl₃ molar ratio | 2.979 | | 2.979 | | 2.979 | | 2.979 | |
| Charge | Cresol 11180-82 lb & | | Cresol 11180-82 lb & | | Cresol 11180-82 lb & | | Cresol 11180-82 lb & | |
| | PCl₃ 4775 lb | | PCl₃ 4775 lb | | PCl₃ 4775 lb | | PCl₃ 4775 lb | |
| Conditions | N₂ sweeping with 15 psi | | N₂ sweeping with 15 psi | | N₂ sweeping with 15 psi | | N₂ sweeping with 15 psi | |
| | 150° C. 1 h hold | | 150° C. 1 h hold with | | Start N₂ sweep & | | Start N₂ sweep & | |
| | and then start | | 15 psi sweeping. | | sparging at 150° C. | | sparging at 150° C. | |
| | sparging/15 psi | | After 1 h at 150° C., | | without any hold at | | without any hold at | |
| | sweeping | | start sparging at 10 CFM. | | 150° C. For sweeping, | | 150° C. Ensure 15 | |
| | | | | | observed 2 CFM | | psi sweep is going | |
| | | | | | for 15 psi N₂ | | in kettle. | |
| | | | | | through flowmeter. | | | |
| | Cresol | Chlorides | Cresol | Chlorides | Cresol | Chlorides | Cresol | Chlorides |
| Sample point | % | (ppm) | % | (ppm) | % | (ppm) | % | (ppm) |
| At 100° C. | — | — | — | — | — | — | — | — |
| At 150° C. | — | — | 6.1 | 14253 | 5.1 | 15424 | 5.7 | 16437 |
| 150° C. 1 h | — | — | 3.9 | 12778 | — | — | — | — |
| 1 h sparge | — | — | — | — | — | — | — | — |
| 2 h sparge | — | — | — | — | — | — | — | — |
| 3 h sparge | 7.3 | 6795 | 3.2 | 11508 | 2.5 | 8790 | 2.34 | 8541 |
| 4 h sparge | — | — | — | — | — | — | — | — |
| 5 h sparge | 2.1 | 5384 | 1.4 | 5450 | 1.7 | 6525 | 1.4 | 6188 |
| 6 h sparge | 1.2 | 5122 | 1.2 | 4684 | 1.5 | 5514 | 1.1 | 5410 |
| 7 h sparge | 1.0 | 4844 | 1.0 | 4072 | 1.4 | 5076 | 1.0 | 4877 |
| 8 h sparge | 1.1 | 4844 | — | — | 1.2 | 4563 | — | — |
| 9 h sparge | — | — | — | — | — | — | — | — |
| 9.5 h sparge | — | — | — | — | — | — | — | — |
| 10 h sparge | — | — | — | — | — | — | — | — |
| 11 h sparge | — | — | — | — | — | — | — | — |
| (Cooling/Lotting) | | | | | | | | |
| Cooling/Lotting | 1.1 | 4478 | 1.0 | 4072 | 1.2 | 4563 | 0.9 | 4266 |

| | | | | |
|---|---|---|---|---|
| Total Cycle | 16 hours | — | — | — |
| Time | | | | |

| Cresol:PCl₃ molar ratio | 2.979 | | 2.979 | | 2.979 | | 2.979 | |
|---|---|---|---|---|---|---|---|---|
| Charge | Cresol 11180-82 lb & | | Cresol 11180-82 lb & | | Cresol 11180-82 lb & | | Cresol 11182 lb & | |
| | PCl₃ 4775 lb | | PCl₃ 4775 lb | | PCl₃ 4775 lb | | PCl₃ 4775 lb | |
| Conditions | N₂ sweeping with 15 psi | | N₂ sweeping with 15 psi | | N₂ sweeping with 15 psi | | N₂ sweeping with 15 psi | |
| | Start 15 psi | | Start 30 psi | | Start 15 psi | | Start 18 psi | |
| | sweeping after PCl₃ | | sweeping | | sweeping after PCl₃ | | sweeping after PCl₃ | |
| | addition. Heat until | | and sparging at | | addition at 95° C. | | addition at 95° C. | |
| | 150° C. with | | 150° C. | | Start sparging at | | Start sparging at | |
| | sweeping, and then | | | | 120° C. Continue | | 100° C. Continue | |
| | start sparging at | | | | heating to 150° C., | | heating to 150° C., | |
| | 150° C. | | | | and | | and | |
| | | | | | sweeping/sparging | | sweeping/sparging | |
| | | | | | at 150° C. | | at 150° C. | |
| | Cresol | Chlorides | Cresol | Chlorides | Cresol | Chlorides | Cresol | Chlorides |
| Sample point | % | (ppm) | % | (ppm) | % | (ppm) | % | (ppm) |
| At 100° C. | — | — | — | — | — | — | 3.5 | 11673 |
| At 150° C. | 4.9 | 13485 | 6.2 | 15170 | 8.9 | 8146 | 3.8 | 11603 |
| 150° C. 1 h | — | — | — | — | — | — | — | — |
| 1 h sparge | — | — | — | — | — | — | — | — |
| 2 h sparge | — | — | — | — | — | — | — | — |
| 3 h sparge | 2.1 | 6412 | 2.2 | 9195 | 2.9 | 5482 | 1.8 | 6119 |
| 4 h sparge | — | — | 1.3 | 6908 | 1.8 | 6051 | 1.6 | 5085 |
| 5 h sparge | 1.4 | 5584 | 1.0 | 5856 | 1.5 | 5526 | 1.5 | 4431 |
| 6 h sparge | 1.2 | 5184 | 0.8 | 5334 | 1.2 | 4745 | 1.1 | 4021 |
| 7 h sparge | 1.1 | 4981 | 0.7 | 4959 | — | — | — | — |
| 8 h sparge | — | — | — | — | — | — | — | — |
| 9 h sparge | — | — | — | — | — | — | — | — |
| 9.5 h sparge | — | — | — | — | — | — | — | — |
| 10 h sparge | — | — | — | — | — | — | — | — |
| 11 h sparge | — | — | — | — | — | — | — | — |
| (Cooling/Lotting) | | | | | | | | |
| Cooling/Lotting | 1.1 | 4981 | 0.7 | 5047 | 1.1 | 4352 | 1.1 | 4021 |
| Total Cycle | — | | — | | — | | — | |
| Time | | | | | | | | |
| Cresol:PCl₃ molar ratio | 2.975 | | 2.979 | | 2.979 | | 2.979 | |
| Charge | Cresol 11180-82 lb & | | Cresol 11184 lb & | | Cresol 11180-82 lb & | | Cresol 11180-82 lb & | |
| | PCl₃ 4616 lb | | PCl₃ 4775 lb | | PCl₃ 4775 lb | | PCl₃ 4775 lb | |
| Conditions | No sweep | | Start 22 psi | | Start 22 psi | | Start 25 psi | |
| | | | sweeping & 10 | | sweeping & 10 | | sweeping & 10 | |
| | | | CFM sparging | | CFM sparging | | CFM sparging | |
| | | | after PCl₃ addition | | after PCl₃ addition | | after PCl₃ addition | |
| | | | (95-96° C.) | | (95-96° C.) | | (95-96° C.) | |
| | Cresol | Chlorides | Cresol | Chlorides | Cresol | Chlorides | Cresol | Chlorides |
| Sample point | % | (ppm) | % | (ppm) | % | (ppm) | % | (ppm) |
| After PCl₃ | — | — | 4.7 | 14173 | 10.8 | 21606 | 6.8 | 22408 |
| addition (95 C.) | | | | | | | | |
| At 100° C. | — | — | — | — | — | — | — | — |
| At 150° C. | — | — | 4.2 | 11051 | 9.4 | 16628 | 3.8 | 11241 |
| 150° C. 1 h | 4.2 | 15347 | — | — | — | — | — | — |
| 1 h sparge | — | — | — | — | — | — | — | — |
| 2 h sparge | — | — | — | — | — | — | — | — |
| 3 h sparge | 2.1 | 8500 | 2.3 | 7707 | 1.9 | 6291 | 1.9 | 6774 |
| 4 h sparge | — | — | 1.6 | 5127 | 1.5 | 5269 | 1.3 | 5157 |
| 5 h sparge | 1.4 | 6475 | 1.3 | 4735 | 1.2 | 4608 | 1.2 | 4384 |
| 6 h sparge | — | — | 1.1 | 3735 | — | — | — | — |
| 7 h sparge | 1.1 | 5321 | — | — | — | — | — | — |
| 8 h sparge | — | — | — | — | — | — | — | — |
| 9 h sparge | — | — | — | — | — | — | — | — |
| 9.5 h sparge | — | — | — | — | — | — | — | — |
| 10 h sparge | — | — | — | — | — | — | — | — |
| 11 h sparge | — | — | — | — | — | — | — | — |
| (Cooling/Lotting) | | | | | | | | |
| Cooling/Lotting | 1.0 | 4730 | 1.1 | 3735 | 1.0 | 3934 | 1.0 | 4085 |

| | | | | |
|---|---|---|---|---|
| Total Cycle | 16.8 hours | — | — | — |
| Time | | | | |

| Cresol:PCl₃ molar ratio | 2.977 | | 2.977 | | 2.977 | |
|---|---|---|---|---|---|---|
| Charge | Cresol 11181 lb & | | Cresol 11182 lb & | | Cresol 11182 lb & | |
| | PCl₃ 4773 lb | | PCl₃ 4773 lb | | PCl₃ 4773 lb | |
| Conditions | Start 25 psi | | Start 25 psi | | Start 25 psi | |
| | sweeping & 10 | | sweeping & 10 | | sweeping & 10 | |
| | CFM sparging | | CFM sparging | | CFM sparging | |
| | after PCl₃ addition | | after PCl₃ addition | | after PCl₃ addition | |
| | (95-96° C.) | | (95-96° C.) | | (95-96° C.) | |
| | Cresol | Chlorides | Cresol | Chlorides | Cresol | Chlorides |
| Sample point | % | (ppm) | % | (ppm) | % | (ppm) |
| After PCl₃ | 6.4 | 19976 | 6.8 | 23022 | 8.0 | 10723 |
| addition (95° C.) | | | | | | |
| At 100° C. | — | — | — | — | — | — |
| At 150° C. | 3.6 | 10609 | 3.5 | 10951 | — | — |
| 150° C. 1 h | — | — | — | — | — | — |
| 1 h sparge | — | — | — | — | — | — |
| 2 h sparge | — | — | — | — | — | — |
| 3 h sparge | 2.0 | 5612 | 1.9 | 5769 | 2.0 | 6448 |
| 4 h sparge | 1.6 | 4897 | 1.5 | 4795 | 1.5 | 5047 |
| 5 h sparge | 1.3 | 4128 | 1.3 | 4049 | 1.2 | 4221 |
| 6 h sparge | — | — | — | — | — | — |
| 7 h sparge | — | — | — | — | — | — |
| 8 h sparge | — | — | — | — | — | — |
| 9 h sparge | — | — | — | — | — | — |
| 9.5 h sparge | — | — | — | — | — | — |
| 10 h sparge | — | — | — | — | — | — |
| 11 h sparge | — | — | — | — | — | — |
| (Cooling/Lotting) | | | | | | |
| Cooling/Lotting | 1.3 | 4128 | 1.3 | 4049 | 1.2 | 4221 |

| | | | |
|---|---|---|---|
| Total Cycle | 13.33 hours | 13.25 hours | — |

Time

Utilizing both sweeping and sparging can reduce the cycle time while bringing the product within a certain limit. In addition, the total sparge time can be reduced from 7-8 hours to 4-5 hours for the product to come into a certain limit based on the residual cresol and total chlorides in the product.

### Example 7

The following example is directed to the synthesis of a high chlorides tristolyl phosphite ester product. Utilizing a 2275 gallon (304 ft³) reactor, cresol (approx. 11180-11182 lbs) was first charged followed by PCl₃ (approx. 4984 lbs). The cresol to PCl₃ molar ratio was approximately 2.85. The reaction was heated to 150° C. In certain examples, nitrogen sparge at 10 cubic feet per minute was initiated (gas hourly space velocity of 1.97/hour). Similarly, in certain examples, nitrogen sweeping was utilized at 25 psi (5-6 CFM, 1.1/hour gas hourly space velocity). In some examples, the sweeping and sparging were started earlier than reaching the 150° C. reaction temperature. For example, in some cases, it was started as soon as the PCl₃ addition was completed and/or when the temperature was 95° C. Also, in some examples, the reaction temperature was 125° C. instead of 150° C. The product resulted in less than 1.5% residual cresol with a chloride content of between 10,000-15,000 ppm.

Utilizing both sweeping and sparging can reduce the cycle time while bringing the product within a certain limit. In addition, the total sparge time can be reduced from 3 hours to 1 hour for the product to come into a certain limit based on the residual cresol and total chlorides in the product. Also, the total batch cycle time can be reduced from 12 hours to 10 hours with these modifications.

These and other modifications and variations of the present disclosure may be practiced by those of ordinary skill in the art, without departing from the spirit and scope of the present disclosure. In addition, it should be understood that aspects of the various embodiments may be interchanged both in whole or in part. Furthermore, those of ordinary skill in the art will appreciate that the foregoing description is by way of example only and is not intended to limit the disclosure so further described in such appended claims.

1-66. (canceled)

67. A method of making a phosphite ester, the method comprising:
reacting a hydroxyl-substituted compound comprising a hydroxyl-substituted alkyl compound, a hydroxyl-substituted aryl compound, or a mixture thereof with a phosphorus halide, wherein the hydroxyl-substituted compound and the phosphorus halide are reacted in a molar ratio of from about 2.3 to about 5, at a temperature of about 200° C. or less to make a product mixture comprising a hydrogen halide and a reaction product comprising the phosphite ester and one or more compounds having the following structure (I) and being present in an amount of about 0.3 wt. % or more to about 15 wt. % or less based on the weight of the reaction product: 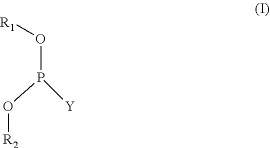
wherein
R₁ is an alkyl or an aryl;
R₂ is an alkyl or an aryl;
Y is Z or —O—H; and
Z is a halide; and
removing the hydrogen halide from the product mixture.

68. The method of claim 67, wherein the phosphorus halide comprises a phosphorus trichloride.

69. The method of claim 67, wherein the hydroxyl-substituted compound comprises a hydroxyl-substituted aryl compound.

70. The method of claim 69, wherein the hydroxyl-substituted alkaryl compound comprises a C₁-C₄ alkyl group substitution.

71. The method of claim 67, wherein the removing step includes a vacuum, a nitrogen sweep, a nitrogen sparge, or a combination thereof.

72. The method of claim 67, wherein the phosphite ester has the following structure: 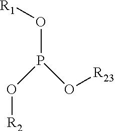
wherein
R₂₁, R₂₂, and R₂₃ are each independently an alkyl or an aryl.

73. The method of claim 72, wherein R₂₁, R₂₂, and R₂₃ are each aryl.

74. The method of claim 73, wherein the aryl comprises a C₁-C₄ alkyl group substitution.

75. The method of claim 67, wherein the phosphite ester has the following structure:

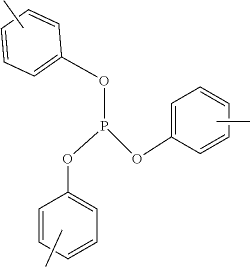

76. The method of claim 67, wherein the phosphite ester has the following structure:

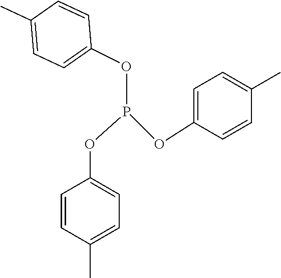

77. The method of claim 67, wherein the one or more compounds of structure (I) has the following structure: 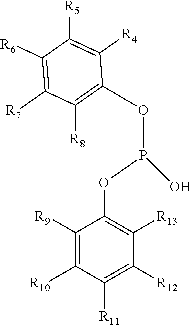
wherein
R₄, R₅, R₆, R₇, R₈, R₉, R₁₀, R₁₁, R₁₂, and R₁₃ are independently hydrogen or an alkyl.

78. The method of claim 67, wherein the one or more compounds of structure (I) has the following structure: 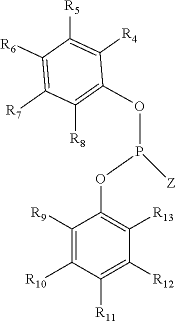
wherein
R₄, R₅, R₆, R₇, R₈, R₉, R₁₀, R₁₁, R₁₂, and R₁₃ are independently hydrogen or an alkyl; and
Z is as defined above.

79. The method of claim 67, wherein the one or more compounds of structure (I) has the following structure: 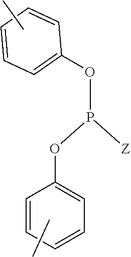
wherein
Z is as defined above.

80. The method of claim 67, wherein the reaction product comprises a first compound having the following structure based on structure (I): 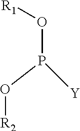
wherein
R₁ and R₂ are as defined above;
Y is Z; and
Z is as defined above; and
a second compound having the following structure based on structure (I): 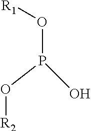
wherein
R₁ and R₂ are as defined above.

81. The method of claim 67, wherein the hydrogen halide comprises hydrogen chloride.

82. The method of claim 67, wherein the phosphite ester is present in the reaction product in an amount of about 80 wt. % or more.

83. The method of claim 67, wherein the compound of structure (I) is present in the reaction product in an amount of about 1 wt. % or more to about 12 wt. % or less.

84. The method of claim 67, wherein the compound of structure (I) is present in the reaction product in an amount of about 2 wt. % or more to about 4 wt. % or less.

85. The method of claim 67, wherein the compound of structure (I) is present in the reaction product in an amount of about 7 wt. % or more to about 12 wt. % or less.

86. The method of claim 67, wherein the reaction product has a chloride content of from about 3,000 ppm to about 15,000 ppm.

87. The method of claim 67, wherein the reaction product has a chloride content of from about 10,000 ppm to about 15,000 ppm.

88. The method of claim 67, wherein the reaction product comprises 1.5 wt. % or less of phenol.

89. The method of claim 67, wherein the hydroxyl-substituted compound and the phosphorus halide are reacted in a molar ratio of from about 2.3 to less than about 3.

90. The method of claim 67, wherein the reacting step is conducted without the presence of a solvent and/or the presence of a catalyst.
